(19) United States
(12) Patent Application Publication
(10) Pub. No.: US 2025/0190931 A1
(43) Pub. Date: Jun. 12, 2025

(54) SYSTEM AND METHOD FOR ADAPTIVELY IDENTIFYING OPTIMAL MODEL TO SELECT ROUTE TO LOCATION

(71) Applicant: GRABTAXI HOLDINGS PTE. LTD., Singapore (SG)

(72) Inventors: Albert VINSENSIUS, Singapore (SG); Yong LIU, Singapore (SG); Kaican KANG, Singapore (SG)

(21) Appl. No.: 18/845,215

(22) PCT Filed: May 19, 2023
(86) PCT No.: PCT/SG2023/050346

§ 371 Date: Sep. 9, 2024

(30) Foreign Application Priority Data
May 20, 2022 (SG) 10202205387S

(51) Int. Cl. G06Q 10/0835; G06Q 10/047

(52) U.S. Cl. CPC G06Q 10/08355; G06Q 10/047

(57) ABSTRACT

The present disclosure provides a system and a method for adaptively identifying an optimal model to select a route to a location, the method comprising: A method for adaptively identifying an optimal model to select a route to a location, comprising: providing one or more first models based on a routing characteristic associated with the location; retrieving one or more first parameters associated with the routing characteristic to determine an effectiveness of each of the one or more first models in minimizing a route expense parameter; and selecting the optimal model from the one or more first models based on the effectiveness.

### TECHNICAL FIELD

The present invention relates generally to a system and a method for identifying an optimal model, more particularly, the system and method adaptively identify an optimal model for selecting a route to a location.

### BACKGROUND

In deliveries business, last-mile routing optimization is an important component which directly impacts consumer experience, cost of delivery, and resource utilization. It can impact consumer experience by affecting the time duration before a delivery is completed—a crucial metric in an instant-delivery service. It can also affect consumer experience when there is a delivery time promise or other delivery requirements such as upkeeping the quality of fresh and frozen goods on delivery. Cost of delivery can also be reduced by a good routing optimization since this cost is directly related to the number of vehicles used as well as the total distance travelled by all vehicles to fulfil all deliveries. Route optimization also improves resource utilization by ensuring that vehicles are used to deliver as many orders as possible while meeting all the prescribed constraints. Such vehicle routing optimization software is also often known as routing optimizers.

Typically, a delivery routing problem is modelled as a Vehicle Routing Problem (VRP) (hereinafter referred to as routing constraint) where the objective function is to minimize the cost of fulfilling all orders (in this case cost can be in terms of monetary cost, distance travelled, time spent on the road, or even a combination of those) (hereinafter referred to as routing expense parameter), while meeting the various constraints as per required by the business. Some of these routing constraints include limited vehicle availability, vehicle capacities, delivery time windows, pickup before delivery, and so on. In a VRP, demand is modelled as a set of node locations to be visited. The problem is usually solved by the routing optimizers to provide solutions that specify the routes to be taken by the vehicles to fulfill customer requests in a certain sequence.

For VRP with small problem/constraint size, they can be solved by routing optimizers based on exact optimization algorithms such as branch-and-bound or column generation. Since exact solving algorithms rely on the mathematical representation of the VRP, they are extensible and flexible by nature. However, they suffer from the curse of dimensionality (i.e. the inability to solve large-scale problems within a reasonable amount of time and computing resources). Thus this type of optimizer is not suitable for solving large-scale VRPs with numerous constraints of different types which is a computationally taxing task, where finding a feasible solution is not trivial. Examples of such general-purpose mathematical optimizers include Google OR tools, Gurobi, CPLEX, etc.

As such, large-scale VRPs are often solved with routing optimizers based on heuristics algorithms and are capable of obtaining a good quality solution within a reasonable amount of time and computing resources. These heuristics-based optimizers are often specialized, developed to solve a particular variant of routing constraint/problem (e.g. with capacity and/or time windows) and do not offer much extensibility and flexibility. Moreover, the heuristics implemented are tuned for the intended variant and often do not do well when solving a different variant of the constraint/problem. This is the no-free-lunch theorem of algorithms which roughly states that no one algorithm is better than all others in solving a given problem—in other words, all algorithms have their own strengths and weaknesses depending on the properties of the problem at hand (e.g. type of constraints, problem size, etc). Examples of such specialized VRP optimizers include OptimoRoute, Circuit, Bringoz, etc.

There is thus a need to devise a novel method and system for adaptively identifying an optimal model to select a route to a location to address the issues, more particularly, to marry the benefits of exact (flexibility and extensibility) and heuristics (scalability and performance) methods.

Furthermore, other desirable features and characteristics will become apparent from the subsequent detailed description and the appended claims, taken in conjunction with the accompanying drawings and this background of the disclosure.

### SUMMARY

In a first aspect, the present disclosure provides a method for adaptively identifying an optimal model to select a route to a location, comprising: providing one or more first models based on a routing characteristic associated with the location; retrieving one or more first parameters associated with the routing characteristic to determine an effectiveness of each of the one or more first models in minimizing a route expense parameter; and selecting the optimal model from the one or more first models based on the effectiveness.

In a second aspect, the present disclosure provides a system for adaptively identifying an optimal route connecting a plurality of destinations, the system comprising: at least one processor; and at least one memory including computer program code; the at least one memory and the computer program code configured to, with at least one processor, cause the server at least to, comprising: provide one or more first models based on a routing characteristic associated with the location; retrieve one or more first parameters associated with the routing characteristic to determine an effectiveness of each of the one or more first models in minimizing a route expense parameter; and select the optimal model from the one or more first models based on the effectiveness.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 shows a block diagram illustrating a system for adaptively identifying an optimal model to select a route to a location according to various embodiments of the present disclosure.

FIG. 2 shows a block diagram illustrating various components of a system for adaptively identifying an optimal model to select a route to a location according to an embodiment of the present disclosure.

FIG. 3 shows a flow chart illustrating a method for adaptively identifying an optimal model to select a route to a location according to an embodiment of the present disclosure.

FIG. 4 shows a flow diagram illustrating relationships of entities according to an embodiment of the present disclosure.

FIG. 5 shows a block diagram illustrating different types of abstract constraints according to an embodiment of the present disclosure.

FIG. 6 shows a block diagram illustrating a route entity data structure according to an embodiment of the present disclosure.

FIG. 7 shows a flow chart illustrating a process of an iterative search flow used for adaptively identifying an optimal model to select a route to a location according to an embodiment of the present disclosure.

FIG. 8 shows a flow chart illustrating a process of an adaptive large neighbourhood search flow used for adaptively identifying an optimal model to select a route to a location according to an embodiment of the present disclosure.

FIG. 9 shows a flow chart illustrating a vehicle routing optimizer and external interfaces for adaptively identifying an optimal model to select a route to a location according to an embodiment of the present disclosure.

FIG. 10A shows a diagram illustrating locations corresponding to Capacitated vehicle routing problem with pickups and deliveries (CVRPPD) problem and an initial model (solution) to select a route(s) to the locations according to an embodiment of the present disclosure.

FIG. 10B illustrates shows a diagram illustrating an improved solution to select a route(s) to the locations from FIG. 10A.

FIG. 11 shows an exemplary implementation of a vehicle routing optimizer according to an embodiment of the present disclosure.

FIG. 12 shows a sample of an input data file according to an embodiment of the present disclosure.

FIG. 13 shows exemplary interface layers implemented for a system for adaptively identifying an optimal model to select a route to a location according to an embodiment of the present disclosure.

FIG. 14 shows a native read-evaluate-print loop (REPL) interface sample according to an embodiment of the present disclosure.

FIGS. 15 and 16 show a schematic diagram of a general purpose computer system upon which the coordination server of FIG. 1 can be practiced.

FIG. 17 shows an alternative computer device to implement the coordination server of FIG. 1.

FIG. 18 shows a schematic diagram of a general purpose computer system upon which the model identification server of FIG. 1 can be practiced.

FIG. 19 shows an alternative computer device to implement the model identification server of FIG. 1.

FIG. 20 shows a schematic diagram of a general purpose computer system upon which a combined coordination and model identification server of FIG. 1 can be practiced.

FIG. 21 shows an alternative computer device to implement a combined coordination and model identification server of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a service request allocation system and method under lack of available service providers condition.

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In various embodiments below, a route refers to a pathway connecting a sequence of locations (nodes) to be visited by a vehicle of a specific vehicle type. For the sake of simplicity, the term “a route to a location” is used. A skilled person would appreciate that such term may refer to a route to more than one location. It is also appreciated that the word “location” in such term may refer to a final/last location (destination) of the sequence of locations where the route connects all other locations of the sequence ending at the final/last location.

Similarly, for the sake of simplicity, the term “an optimal model to select a route” is used. It is appreciated that such term may refer to an optimal model to select multiple routes, each of the routes referring to a pathway connecting a sequence of locations to be visited. The multiple routes may lead to the same location (or destination) or different locations (or destinations).

Such optimal model may also be applied to first-mile delivery, middle-mile delivery or last-mile delivery or a combination thereof. For example, in a hub-and-spoke model where multiple items have been batched together, a driver may collect the items from multiple sources, and deliver them to an origin hub (“first-mile” delivery). From here, the items may be to delivered a destination hub (“middle-mile” delivery). At the destination hub, orders may be batched, sorted according to batch, and then delivered to their respective destinations (“last-mile” delivery). Accordingly, in some examples, multiple orders are being picked up by a single driver for delivery to a single destination, as opposed to multiple orders being delivered to multiple destinations. According to the present disclosure, the same optimal model (or optimization algorithm) as applied to first-mile delivery can also be applied to the middle-mile delivery and/or last mile delivery, and vice versa, to select an optimal route. In other words, a method and a system for adaptively identifying an optimal model that is able to select an optimal route (or near optimal route) for a driver to take to pick up all their allocated orders en route to the origin hub, pick up from one or more origin hub to one or more destination hubs, and/or pick up from a destination hub to multiple destinations are provided.

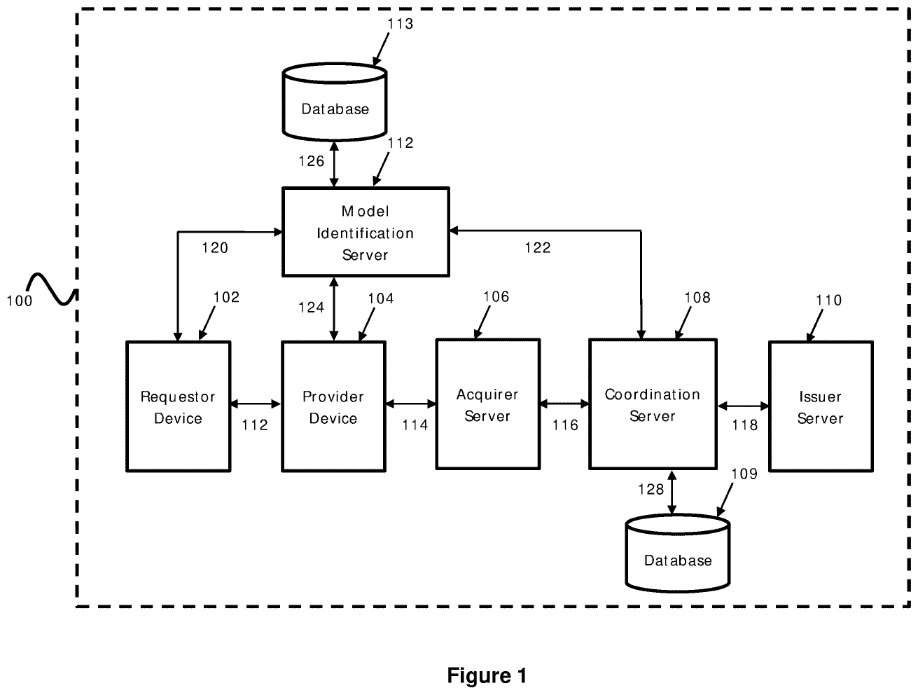

According to various embodiments of the present disclosure, the process of adaptively identifying an optimal model to select a route to a location can implemented through a system. FIG. 1 shows a block diagram illustrating a system 100 for adaptively identifying an optimal model to select a route to a location according to an embodiment. Further, the system 100 may enable a transaction for a good or service, and/or a request for a good or service (e.g., model data, route data, vehicle data, location data, model identification service or route selection service) between a requestor and a provider (herein may referred to as “users”).

The system comprises a requestor device 102, a provider device 104, an acquirer server 106, a coordination server 108, an issuer server 110 and a model identification server 112.

A user may be any suitable type of entity, which may include a consumer, company, corporation or governmental entity (i.e., requestor) who looking to purchase or request for a good or service (e.g., model data, route data, vehicle data, location data, model identification service or route selection service) via a coordination server 108, an application developer, company, corporation or governmental entity (i.e., provider) who looking to sell or provide a good or service (e.g., model data, route data, vehicle data, location data, model identification service or route selection service) via a coordination server 108.

A requestor device 102 is associated with a customer (or requestor) who is a party to, for example, a request for a good or service that occurs between the requestor device 102 and the provider device 104. The requestor device 102 may be a computing device such as a desktop computer, an interactive voice response (IVR) system, a smartphone, a laptop computer, a personal digital assistant computer (PDA), a mobile computer, a tablet computer, and the like.

The requestor device 102 may include user credentials (e.g., a user account) of a requestor to enable the requestor device 102 to be a party to a transaction. If the requestor has a user account, the user account may also be included (i.e., stored) in the requestor device 102. For example, a mobile device (which is a requestor device 102) may have the user account of the customer stored in the mobile device.

In one example arrangement, the requestor device 102 is a computing device in the form of a watch or similar wearable and is fitted with a wireless communications interface (e.g., a NFC interface). The requestor device 102 can then electronically communicate with the provider device 104 regarding a transaction or coordination request. The customer uses the watch or similar wearable to make a request regarding the transaction or coordination request by pressing a button on the watch or wearable.

A provider device 104 is associated with a provider who is also a party to the request for a good or service that occurs between the requestor device 102 and the provider device 104. The provider device 102 may be a computing device such as a desktop computer, an interactive voice response (IVR) system, a smartphone, a laptop computer, a personal digital assistant computer (PDA), a mobile computer, a tablet computer, and the like.

Hereinafter, the term “provider” refers to a service provider and any third party associated with providing a good or service for purchase via the provider device 104. Therefore, the user account of a provider refers to both the user account of a provider and the user account of a third party (e.g., a route coordinator) associated with the provider.

If the provider has a user account, details of the user account may also be included (i.e., stored) in the provider device 104. For example, a mobile device (which is a provider device 104) may have user account details (e.g., account number) of the provider stored in the mobile device.

In one example arrangement, the provider device 104 is a computing device in the form of a watch or similar wearable and is fitted with a wireless communications interface (e.g., a NFC interface). The provider device 104 can then electronically communicate with the requestor to make a request regarding the transaction or travel request by pressing a button on the watch or wearable.

An acquirer server 106 is associated with an acquirer who may be an entity (e.g. a company or organization) which issues (e.g. establishes, manages, administers) a payment account (e.g. a financial bank account) of a merchant (e.g., provider). An example of an acquirer is a bank or other financial institution. As discussed above, the acquirer server 106 may include one or more computing devices that are used to establish communication with another server (e.g., the coordination server 108) by exchanging messages with and/or passing information to the other server. The acquirer server 106 forwards the payment transaction relating to a transaction or transport request to the coordination server 108.

A coordination server 108 is configured to carry out processes relating to a user account by, for example, forwarding data and information associated with the transaction to the other servers in the system 100, such as the model identification server 112. In an example, the coordination server 108 may provide location data, vehicle data, route data, model data associated with a request including parameters that may be used for the adaptive model identification and route selection/generation processes by the model identification server 112. An image may be determined based on an outcome of the preview process e.g. an image corresponding to a drop-off point for a location based on the location information.

An issuer server 110 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the requestor device 102. As discussed above, the issuer server 110 may include one or more computing devices that are used to establish communication with another server (e.g., the coordination server 108 by exchanging messages with and/or passing information to the other server.

The coordination server 108 may be a server that hosts software application programs for processing transaction or coordination requests, for example, purchasing of a good or service by a user. The coordination server 108 may also be configured for processing coordination requests between a requestor and a provider. The coordination server communicates with other servers (e.g., model identification server 112) concerning transaction or coordination requests. The coordination server 108 may communicate with the model identification server 112 to facilitate adaptive identification of an optimal model to select a route to a location associated with the transaction or coordination requests. The coordination server 108 may use a variety of different protocols and procedures in order to process the transaction or coordination requests.

In an example, the coordination server 108 may receive transaction and location, vehicle, route and model data associated with a request including problem contexts, constraints, routing characteristics, routing expenses related to a location or the request in general, and parameters used in a model from one user device (such as the requestor device 112 or the provider device 114) and provide the data to the model identification server 112 for use in the adaptive optimal model identification and route selection processes.

Additionally, transactions that may be performed via the coordination server include good or service purchases, credit purchases, debit transactions, fund transfers, account withdrawals, etc. Coordination servers may be configured to process transactions via cash-substitutes, which may include payment cards, letters of credit, checks, payment accounts, tokens, etc.

The coordination server 108 is usually managed by a service provider that may be an entity (e.g. a company or organization) which operates to process transaction or coordination requests. The coordination server 108 may include one or more computing devices that are used for processing transaction or coordination requests.

A user account may be an account of a user who is registered at the coordination server 108. The user can be a customer, a service provider (e.g., a ride-hailing or delivery service provider), or any third parties (e.g., a map/route planner) who want to use the coordination server. A user who is registered to a coordination server 108 or a model identification server 112 will be called a registered user. A user who is not registered to the coordination server 108 or model identification server 112 will be called a non-registered user.

The coordination server 108 may also be configured to manage the registration of users. A registered user has a user account which includes details and data of the user. The registration step is called on-boarding. A user may use either the requestor device 102 or the provider device 104 to perform on-boarding to the coordination server 108.

The on-boarding process for a user is performed by the user through one of the requestor device 102 or the provider device 104. In one arrangement, the user downloads an app (which includes, or otherwise provides access to, the API to interact with the coordination server 108) to the requestor device 102 or the provider device 104. In another arrangement, the user accesses a website (which includes, or otherwise provides access to, the API to interact with the coordination server 108) on the requestor device 102 or the provider device 104. The user is then able to interact with the model identification server 112. The user may be a requestor or a provider associated with the requestor device 102 or the provider device 104, respectively.

Details of the registration include, for example, name of the user, address of the user, emergency contact, next-of-kin contact, vehicle plate number, vehicle type, permissions to retrieve data and information from the requestor device 102 and/or the provider device 104. Alternatively, another mobile device may be selected instead of the requestor device 102 and/or the provider device 104 for retrieving the details/data. Once on-boarded, the user would have a user account that stores all the details/data.

It may not be necessary to have a user account at the coordination server 108 to access the functionalities of the coordination server 108. However, there may be functions that are available only to a registered user for example the provision of certain choices of advance parameters for processing and identifying an optimal model. The term user will be used to collectively refer to both registered and non-registered users. A user may interchangeably be referred to as a requestor (e.g. a person who requests for a route to a location or a model to identify such route) or a provider (e.g. a person who provides an optimal model among multiple models to select a (optimal) route to the location).

The coordination server 108 may be configured to communicate with, or may include, a database 109 via connection 128. The connection 128 may be over a network (e.g., a local area network, a wide area network, the Internet, etc.). The database 128 stores user details/data as well as data corresponding to a transaction (or transaction data). Examples of the transaction data include Transaction identifier (ID), Merchant (Provider) ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant/provider, time and date relating to the transaction of goods/services.

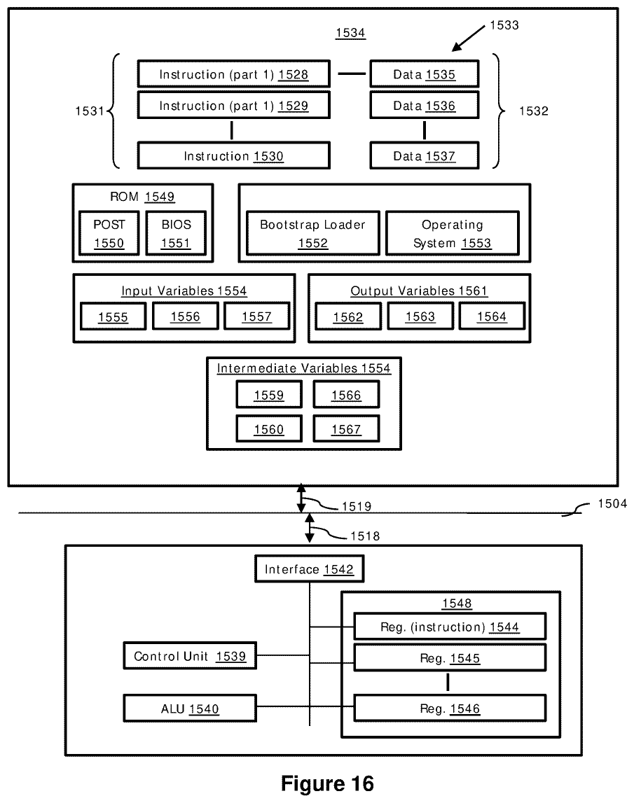

A model identification server 112 may be a server that hosts model and route identification software application programs for adaptively identifying an optimal model to select a route to a location. In one embodiment, each node is associated with a road within a graph/map. In one example, the model identification server 112 may obtain data relating to a node/location, a vehicle, a route, a subnetwork, or a graph network (e.g., problem contexts, constraints, routing characteristics, routing expenses related to a location) and/or their model processing parameters, for example. in the form of a request, from a user device (such as the requestor device 112 or the provider device 114) or the coordination server 108, and use the data for adaptively identifying an optimal model to select a route to a location. The model identification server may be implemented as shown in FIGS. 15, 18 and 20.

The model identification database 113 stores model data comprising data relating locations, routes and vehicles. The location data may be geo-tagged with a geographical coordinate (e.g. latitudinal and longitudinal coordinates) and map-matched to locate a location using location coordinates. The model identification database may be a component of the model identification server 112. In an example, the model identification database 113 may be a database managed by an external entity and the model identification database 113 is a server that, based on a request received from a user device (such as the requestor device 112 or the provider device 114) or the coordination server 108, retrieve model data (e.g. from the model identification database 113) and transmit the data to the user device or the coordination server 108. Alternatively, a module such as a model identification module may store the model data instead of the model identification database 113, wherein the model identification module may be integrated as part of the model identification server 112, or may be external to the model identification server 112.

Use of the term ‘server’ herein can mean a single computing device or a plurality of interconnected computing devices which operate together to perform a particular function. That is, the server may be contained within a single hardware unit or be distributed among several or many different hardware units.

The requestor device 102 is in communication with the provider device 104 via a connection 112. The connection 112 may be an ad hoc connection (e.g., via NFC communication, Bluetooth, etc.) or over a network (e.g., the Internet). The requestor device 102 is also in communication with the model identification server 112 via a connection 120. The connections 112, 120 may be a network connection (e.g., the Internet). The requestor device 102 may also be connected to a cloud that facilitates the system 100 for adaptively identifying an optimal model to select a route to a location. For example, the requestor device 102 can send a signal or data to the cloud directly via an ad hoc connection (e.g., via NFC communication, Bluetooth, etc.) or over a network (e.g., the Internet).

The provider device 104 is in communication with the requestor device 112 as described above, usually via the coordination server 108. The provider device 104 is, in turn, in communication with the acquirer server 106 via a connection 114. The provider device 104 is also in communication with the model identification server 112 via a connection 124. The connections 114 and 124 may be network connections (e.g., provided via the Internet). The provider device 104 may also be connected to a cloud that facilitates the system 100 for adaptively identifying an optimal model to select a route to a location. For example, the provider device 104 can send a signal or data to the cloud directly via an ad hoc connection (e.g., via NFC communication, Bluetooth, etc.) or over a network (e.g., the Internet).

The acquirer server 106, in turn, is in communication with the coordination server 108 via a connection 116. The coordination server 108, in turn, is in communication with an issuer server 110 via a connection 118. The connections 116 and 118 may be over a network (e.g., the Internet).

The coordination server 108 is further in communication with the model identification server 112 via a connection 122. The connection 122 may be over a network (e.g., a local area network, a wide area network, the Internet, etc.). In one arrangement, the coordination server 108 and the model identification server 112 are combined and the connection 122 may be an interconnected bus.

The model identification server 112, in turn, is in communication with a model identification database 113 via a connection 126. The connection 126 may be a network connection (e.g., provided via the Internet). The model identification server 112 may also be connected to a cloud that facilitates the system 100 for adaptively identifying an optimal model to select a route to a location. For example, the model identification server 112 can send a signal or data to the cloud directly via a wireless ad hoc connection (e.g., via NFC communication, Bluetooth, etc.) or over a network (e.g., the Internet).

In the illustrative embodiment, each of the devices 102, 104, and the servers 106, 108, 110, 112 provides an interface to enable communication with other connected devices 102, 104 and/or servers 106, 108, 110, 112. Such communication is facilitated by an application programming interface (“API”). Such APls may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. Examples of APIs include the REST API, and the like. For example, it is possible for at least one of the requestor device 102 and the provider device 104 to receive or submit a request to identify an optimal model to select a route to a location in response to an enquiry shown on the GUI running on the respective API.

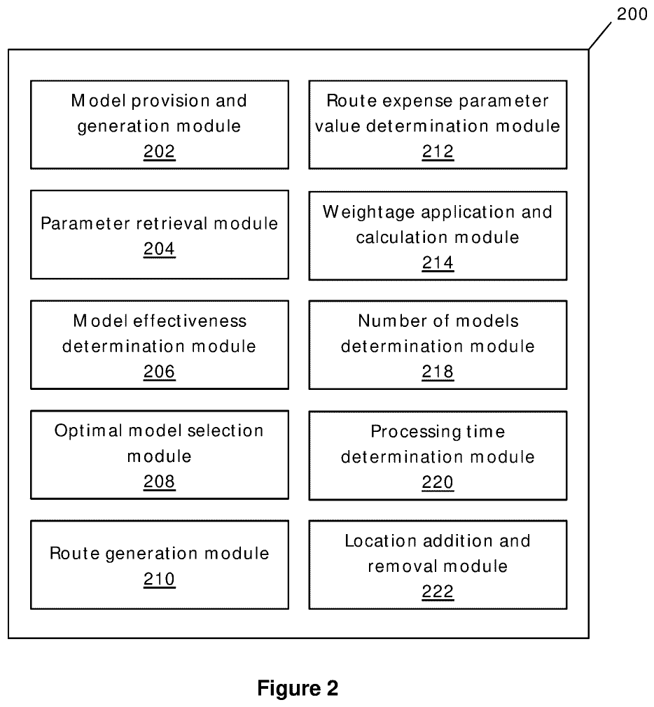

FIG. 2 shows a block diagram illustrating various components of a system 200 for adaptively identifying an optimal model to select a route to a location according to an embodiment of the present disclosure. The system 200 ma comprise a model provision and generation module 202, a parameter retrieval module 204, a model effectiveness determination module 206, an optimal model selection module 208, a route generation module 210, a route expense parameter value determination module 212, a weightage application and calculation module 214, a number of models determination module 218, a processing time determination module 220 and a location addition and removal module 222.

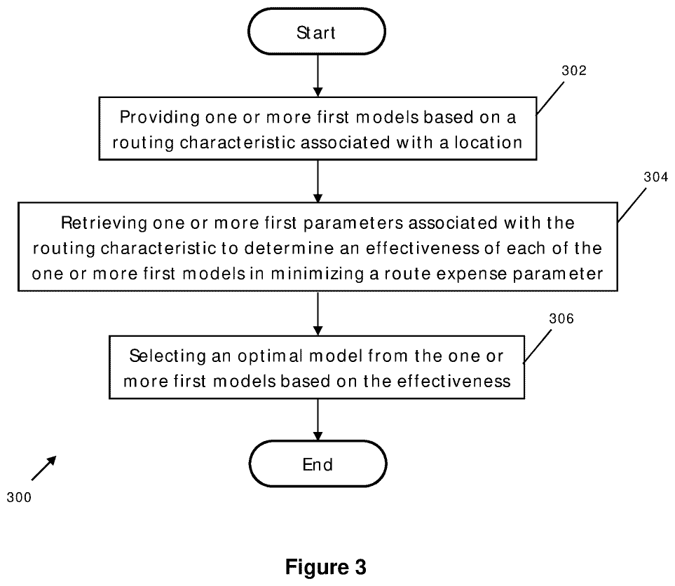

As shown in the exemplified method for adaptively identifying an optimal model to select a route to a location in FIG. 3, the system 200, when in operation, is configured to perform the following steps:
step 302: providing one or more first models based on a routing characteristic associated with a location;
step 304: retrieving one or more first parameters associated with the routing characteristic to determine an effectiveness of each of the one or more first models in minimizing a route expense parameter; and
step 306: a step of selecting an optimal model from the one or more first models based on the effectiveness.

In step 302, the model provision and generation module 202 is configured to provide one or more first models based on a routing characteristic associated with the location. According to an embodiment, the parameters associated with the routing characteristic are a location coordinate, a distance, a time, a load and a number of items to be unloaded/picked up at the location; a type, a load capacity, a speed and a capability of a vehicle; a number of available vehicles; and an accumulated time constraint, an accumulated distance constraint, an accumulated load constraint, a route sequence constraint, an arrival time window constraint and/or a vehicle type constraint associated with the location.

The route generation module 210 is configured to generate a route (initial route) to the location, a vehicle type, a distance. a time and/or a load of the location (e.g., a load be picked up or unloaded at the location) for each of the one or more first models, and the optimal model selection module 208 is configured to further identify the route to the location, the vehicle type, the distance, the time and the load of the location as those of the optimal model when identifying the optimal model. Alternatively, the route generate module 210 may generate a route to the location, a vehicle type, a distance, a time and/or a load of the location (e.g., a load be picked up or unloaded at the location) for only the optimal module upon selecting the optimal model in step 306.

In step 304, the parameter retrieval module 204 is configured to retrieve one or more parameters associated with the routing characteristic, and the model effective determination module 206 is configured to determine an effectiveness of each of the one or more first models in minimizing a route expense parameter. In one embodiment, the model effectiveness determination module 206 is combined with and formed part of the parameter retrieval module 204. According to an embodiment, the route expense parameter is at least one of a load balancing cost, a travel time, a travel distance, a vehicle usage, an accumulated load at the location.

Additionally, the route expense parameter module 212 is configured to determine a value of the route expense parameter based on the one or more parameters of the each of the one or more first models, where a high route expense parameter value indicates a low effectiveness of the model in minimizing the route expense parameter, and the optimal model selection module 208 is configured to select the optimal model from the one or more first models based on the route expense parameter value.

Additionally, the weightage application and calculation module 214 may be configured to apply a weightage of the value of the route expense parameter of the each of the one or more first models determined by the route expense parameter module 212, and the optimal model selection module 208 is configured to select the optimal model from the one or more first models based on the weighted route expense parameter value.

In step 306, the optimal model selection module 208 is configured to select one of the one or more first models based on its effectiveness, e.g., one that has a highest effectiveness among all first models, and identify it as the optimal model.

The model provision and generation module 202 may be configured to further generate a new model from the optimal model generated by the optimal model selection module 208 in step 306. The model effectiveness determination module 206 then determine if an effectiveness of the new model in minimizing the route expense parameter is greater than the effectiveness of the optimal model and the optimal model selection module 208 set/update the new model as the new/updated optimal model in response to a result of the determination, for example that the effectiveness of the new model is indeed greater than that of the optimal model in minimizing the route expense parameter.

Similarly, the route generation module 210 is configured to further generate a new route to the location, a vehicle type, a distance, a time and/or a load of the location (e.g., a load be picked up or unloaded at the location) for the new model and the optimal model selection module 208 is configured to further identify the route to the location, the vehicle type, the distance, the time and the load of the location as those of the new optimal model when setting the second model as the new optimal model.

The location addition and removal module 222 which is configured to add a new location to the route to generate the new route. Where the location is one of multiple locations and the route connects the multiple locations into a sequence, the location addition and removal model 222 may either remove the location from the route or switch the sequence of location and another location within the multiple locations to generate the new route.

The model effectiveness determination module 206 may further determine if the effectiveness of the new model is greater than an effectiveness of a previously generated new model, for example stored in a database (not shown), and the optimal model selection module is configured to set the new model as the new optimal model in response to determining that the effectiveness of the new model is also greater than the effectiveness of the previously generated new model. In one embodiment, the new model is one of many new models and the model provision and generation module 202 is configured to generate the new model (i.e., the one of the many new models) from the optimal model based a weightage. More particularly, the new model having a highest weightage as compared to that of the remaining new models are identified.

The weightage application and calculation module 214 may be configured to increase or decrease the weightage of the new model in response of the result of the determination of the effectiveness of the new model. For example, if the effectiveness of the new model is greater than the optimal model, the weightage of the new model is increased and/or the weightage of the remaining of the many new models is decreased such that the model provision and generation module 202 will subsequently more inclined to select the new model over the remaining new models.

In one embodiment, the number of models determination module 218 is configured to determine if a total number of new models generated by the model provision and generation module 202, for example based on the optimal model. The model provision and generation module 202 is configured to continue generating a new model based on the updated optimal model if the number of models determination module 218 determines that the total number of new models generated does not exceed the pre-configured threshold condition.

Additionally or alternatively, the processing time determination module 220 is configured to determine if a total processing time of the system 200 in adaptively identifying the optimal model to select a route to the location exceed a pre-configured threshold condition. The model provision and generation module 202 is configured to continue generating a new model based on the updated optimal model if the processing time determination module 220 determines that the total processing time does not exceed the pre-configured threshold condition.

As mentioned earlier, the present disclosure provides a system (herein referred to as vehicle routing optimizer or VRO), e.g., the system 200 in FIG. 2 and the model identification server in FIG. 1, which marries the benefits of exact (flexibility and extensibility) and heuristics (scalability and performance) methods for adaptively identifying an optimal model to select a route to a location. A design for a vehicle routing optimizer which is (1) flexible and extensible, (2) adaptive, and (3) high-performance and scalable is described.

First, it is flexible by nature of its modularity to be able to model different variants of VRP, ranging from general capacities, time window, pickup-and-delivery, multi-vehicle types, multi-depot, with delivery precedence, etc. Second, it is adaptive by having multiple algorithms implemented (each suitable for handling different constraints and requirements) and dynamically selecting which algorithms to use at different phases of the optimization process. Finally, it is high performance by being able to obtain high-quality solutions for large-scale problems within a reasonable amount of time. In this manner, we reap the benefits of both exact and heuristics approaches.

In particular, the present disclosure provides a design for a flexible, adaptive a high performance vehicle routing optimizer which which sets apart from known routing optimizer. The flexibility of the VRO in this disclosure is achieved through a vehicle routing-specific entities modelling. The adaptiveness of the VRO in this disclosure is accomplished through a general optimization framework. The high performance of the VRO in this disclosure is attained by a specialized implementation of data structures and algorithms. Detailed implementations of the VRO are described in the following paragraphs.

In various embodiments below, the terms “model” and “solution” may be used interchangeably. In other words, the best solution (i.e., optimal model) is selected and identified to select a route (or optimal route) to a location according to the present disclosure. It is noted that the term “routing constraint” and “vehicle routing problem” or “VRP” are also used interchangeably in the following paragraphs.

In terms of flexibility, the entities involved in a vehicle routing problem are modelled in an efficient and modular manner. These entities can be categorized into two main categories: (1) ProblemContext and (2) Solution.

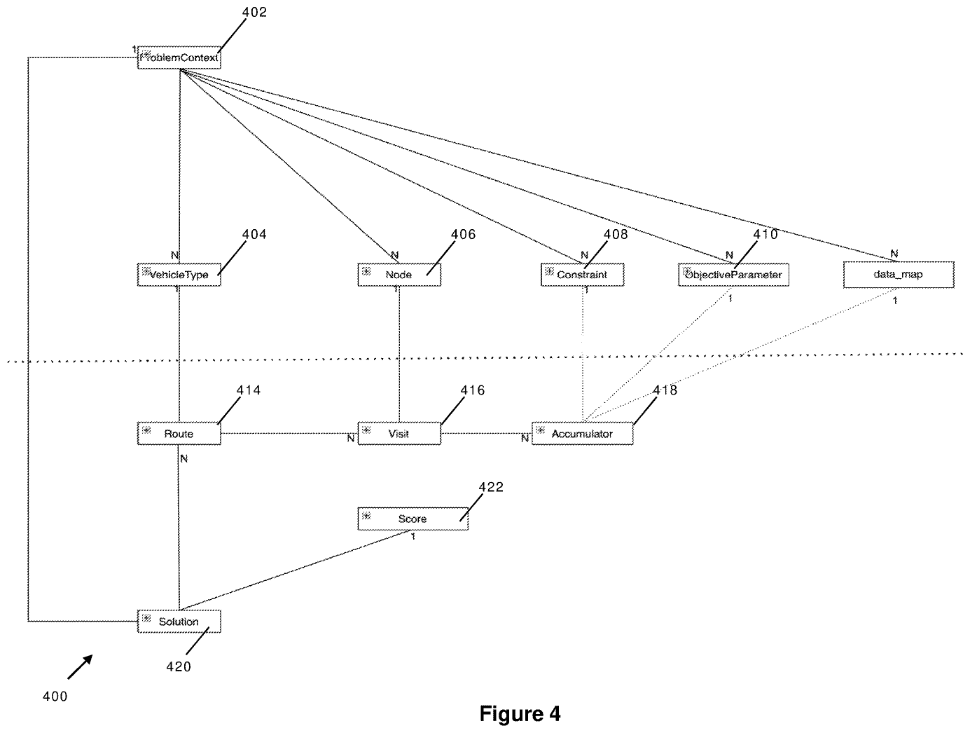

FIG. 4 shows a flow diagram 400 illustrating relationships of entities according to an embodiment of the present disclosure. The ProblemContext entity 402 is a composite entity used to store all the problem related input data and contains sub-entities that collectively describe the routing constraint or vehicle routing problem (VRP) to be solved. These sub-entities of the ProblemContext entity 402 are Node 406, DataMatrix (not shown), Constraint 408, ObjectiveParameter 410, VehicleType 404. The Solution entity 420, on the other hand, is a composite entity which describes the solution (optimal model) to the given problem (output of the optimizer). The solution (optimal model) is a set of routes each containing a sequence of nodes to visit by a vehicle of a specific vehicle type. The Solution entity 420 comprises the sub-entities Route 414, Visit 416, Accumulator 418, and Score 422.

Each of the sub-entities is designed to follow the single responsibility principle such that they serve a single purpose in the problem modelling and are easily decoupled. The sub-entities are generic and can accommodate different types of concrete data to represent different variants of the routing constraints.

The Node entity 406 describes the location to be visited. It contains location data and information such as the geographical coordinates (e.g. latitudinal and longitudinal coordinates) of the location, the load or mix of items to be delivered or picked up at each location (node), the constraint bounds when visiting the location (e.g. time window), and service time at the location (i.e. how long a vehicle will stop for at the location). Such constraint bounds related to the location may alternatively include in the Constraint entity 408.

The VehicleType entity 404 contains information about the vehicle types such as capacity, travel distance, fuel efficiency, travel times, compatibility, initial values related to the vehicle. These data will be used in the accumulator computation (e.g. total distance, total load, etc), which are checked in the constraints and summarised in objective function. Constraint and Accumulator sub-entities will be described subsequently.

The Constraint entity 408 in the design is used to model different types of constraints presented in different variants of VRPs. For example, for a routing constraint with capacity, one may add a Constraint 408 related to capacity. In another instance, there can be multiple relationships between nodes—distance, time, cost—which can be described by DataMatrix (not shown) and incorporated into the ObjectiveParameter entity 410 into a multi-objective optimization. The ability to flexibly describe different routing constraint variant is attained by these generic ProblemContext sub-entities without the user having to make changes to the underlying sub-entities. Instead, what the user has to do is to create concrete sub-entities which appropriately describe the particular problem variant to be solved.

In one embodiment, the Constraint entity 408 contains vehicle type and location (node) constraints that are otherwise contained in the VehicleType entity 404 and Node entity 406. In another embodiment, beside common constraints like time window, capacity, pickup-delivery, the Constraint entity 408 may contain abstract constraints to include more exotic constraints, thereby increase its routing constraint variety and also flexibility in identifying different optimal models for different variants of VRP.

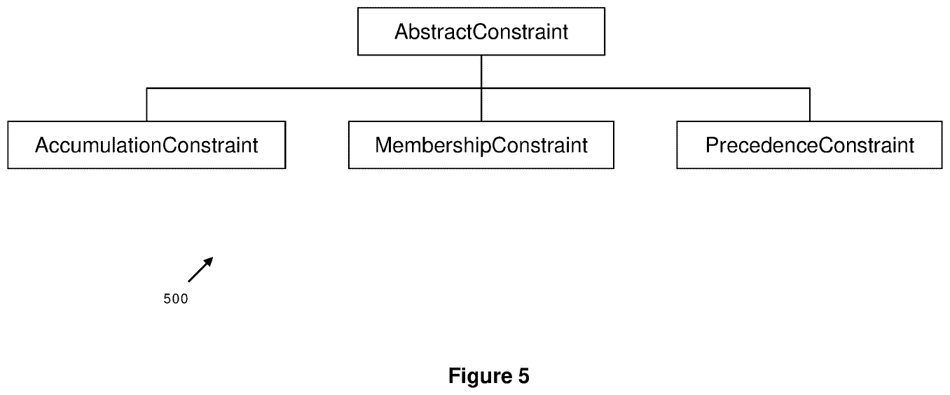

Abstract constraints can be categorized three different types: accumulation constraint, membership constraint and precedence constraint. FIG. 5 shows a block diagram illustrating three different types of abstract constraints contained in Constraint entity 408 in FIG. 4 according to an embodiment of the present disclosure. The AbstractConstraint entity comprises AccumulationConstraint entity, MembershipConstraint and PrecedenceConstraint. The AccumulationConstraint entity is used to model constraints that are posed on certain cumulative quantities (e.g., time, distance, load) along the route. Common examples like time-window constraint or capacity constraint fall into this category; for example, the total load of the vehicle along a route should not exceed a certain quantity. In other times, we have constraints on the vehicle types that can be used to serve certain customer requests. For instance, some frozen items like ice cream or fish can only be delivered by vehicles that have fridges or chilled boxes. This kind of constraint can be modelled using MembershipConstraint in the design, specifying which customer requests can be served by which vehicle types. As for the PrecedenceConstraint, it is used to constrain or limit a sequence to visit multiple locations, e.g., the visiting sequence of customers, in a route. Like in the pickup-delivery VRP, it's required that an item is picked up before it can be delivered. Sometimes, we may also require all items to be picked up before any drop offs. These kinds of constraints can be modelled using PrecedenceConstraint. With this kind of generalization, we are able to model almost all the common constraints seen in different variants of VRPs.

In one implementation, a user might be a social seller doing high volume or orders, or an SME. The user may do a bulk upload of orders to be delivered to multiple destinations. The order data from the bulk upload are input to the optimizer (each line in the order data corresponding to a node along the route). If the user does not specify any sequence, then the optimizer may simply determine the optimal route to carry out all the deliveries. If a sequence is specified in the input order data, such user requirement may be used as a constraint (e.g., PrecedenceConstraint) for the optimization. As a further option, batches can be defined prior to the route optimization. These can be user-defined or determined automatically or semi-automatically, for example, by clustering the orders according to pick-up location/destination. The defined batches can be used as further constraints for the optimization. In other words, a user has some abilities to direct or indirectly input a constraint and influence the optimization in finding the optimal route to fulfil the user's requirement.

In one example, a set of factory methods are provided together in the design so that common constraints can be input easily; while for other more exotic constraints, users can still utilise this AbstractConstraint entity design to implement the required constraints accordingly.

The Accumulator entity 418 in the Solution entity 420 is implemented to perform accumulation on the cumulative quantities received from the Constraint entity 408 and calculate a sum will be used for the comparison with quantity boundaries or limits to determine the feasibility of the constraint. The separation of the Accumulator 418 from the Constraint entity 408 allow observations of single responsibility design principle and the Constraint entity 408 serves a single purpose of feasibility analysis. Better extensibility and maintainability can be achieved with this design.

Another important aspect of VRP is the objective function used in modelling. For different variants of VRPs, different objective functions are used to determine a routing expense parameter or a score indicative of an effectiveness of the solution in achieving the objective, for example, in minimizing a routing expense in terms of vehicle usage cost, time cost, distance cost a load/routing balancing cost, or a combination thereof. To incorporate this flexibility into the problem modelling, the ObjectiveParameter entity 410 is included in the optimizer. Essentially, the ObjectiveParameter entity 410 consists of different sets of weightages or weight parameters to various costs (e.g., routing, vehicle usage, and route balancing costs). Different weights can be specified by users according to their use cases. For example, if the users do not wish to consider the route balancing penalty in determining the score, they can simply set the associated weight parameter to zero. Multi-objective optimization is also supported by specifying corresponding weights for each term in the objective function.

The Score entity 422 simply stores the routing expense parameter values of different models calculated from parameters or data retrieved from ProblemContext 402 sub- entities. A high routing expense parameter value indicates a high routing expense of a route generated a model and corresponds to a low effectiveness (or feasibility) of the model in minimizing the routing expense of a route. The key benefit of this implementation is that the Solution entity 420 interacts with ProblemContext entity 402 closely, so that the flexibility in describing the ProblemContext entity 402 is extended to the Solution entity 420. The corresponding solution algorithms will then be able to take into account all the different requirements described in ProblemContext entity 402 automatically, without any user intervention.

The Score entity 422 may also be used to compare the routing expense parameter values of different models and select an optimal model with the lowest routing expense parameter values (highest effectiveness). The Solution entity 420 then output the optimal model to be used in the optimization framework and subsequent iterative search procedure.

One key implementation is the Route entity 414 and its data structure. Routes entity 414 describe the (near) optimal vehicle routes, including which vehicle type to use and the sequence of nodes to visit, including the relevant cumulative metrics (e.g. time, load) at each visit. The Route data structure encapsulates the sequence of nodes to be visited by a vehicle. The entire Solution to the VRP can then be represented by a set of Routes. The implementation of the Route data structure is crucial to the performance of the optimizer since the search heuristics in the optimization framework rely heavily on manipulation of the Routes; the more efficient the Routes can be manipulated, the more the solution space can be explored and hence the better the final solution will be, given a limited amount of time.

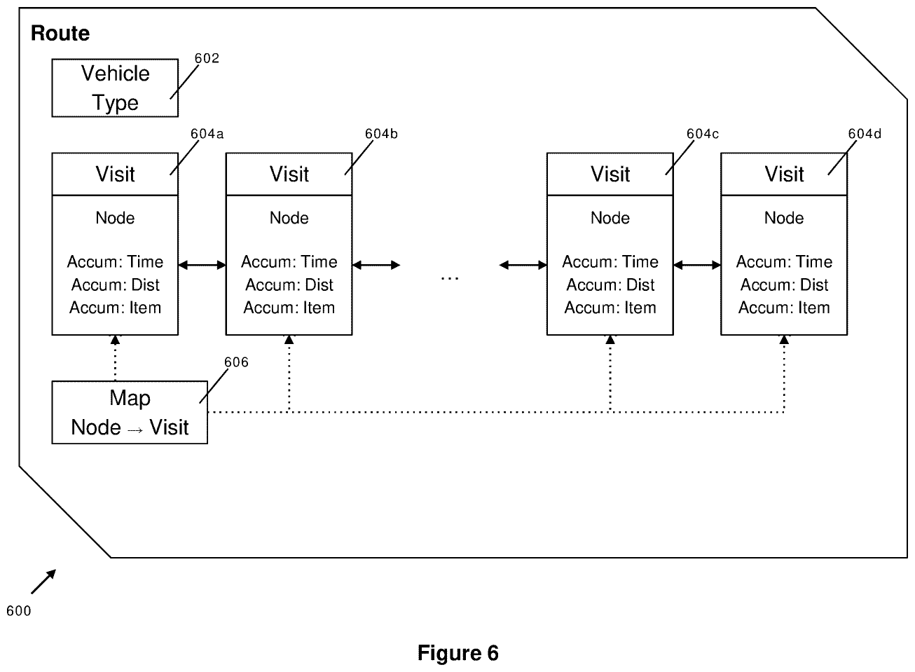

FIG. 6 shows a block diagram 600 illustrating a route entity data structure of Route entity 414 in FIG. 4 according to an embodiment of the present disclosure. Concretely, the Visit entity 416 encapsulates information on the node to be visited as well as the accumulated quantities (e.g., time, distance, items, etc) up to that visit. Route data structure is implemented as a doubly-linked-list of Visit structures 604a-d comprised on Visit entity 416, with additional information on vehicle type 602 (i.e., which vehicle type is serving the route). A node is a demand to be visited. The Route entity 414 also contains a map showing a sequence of nodes to be visited which translates a Node to Visit structure 606.

It is noted that the modelling is both specialized (i.e., entities are specific to vehicle routing problems) and general (i.e. entities can effectively model different requirements within the field of vehicle routing). With this specialized-yet-general set of entities shown in FIG. 4, different variants of VRP can be modelled and solved in an efficient and modular manner with great flexibility. The extension and modification of the entities can also be easily achieved to accommodate customised VRPs.

In term of adaptiveness, the design of this optimizer allows for an adaptive and extendible vehicle routing optimization through the optimization framework. The internal implementation of this optimization framework is an iterative search flow. This framework is designed and implemented from two aspects: (1) Internally, the framework builds a general flow for solving a VRP problem, which starts from an initial optimal solution, for example selected based on the routing expense parameter as described above, and then with multiple iterations of improvement algorithm. The framework is able to be adapted and extended with any algorithm following the flow. (2) Externally, the framework provides a general interface to the end users, allowing users to configure the algorithms dynamically.

In particular, the initial solution constructed is feasible with respect to the routing constraints derived or determined based on the input, but typically far from optimal since only a short amount of time is used for initial construction. Without a loss of generality, it is possible to execute multiple construction algorithms to obtain different initial solutions, and proceed to the next step with the best initial solution.

Then, given the initial solution, the optimizer iterates through different search algorithms to improve the solution. The optimizer spends most of the time iterating through these algorithms and improving the solution. Finally, the best solution found so far is finally returned to the user after a predetermined amount of time specified by the user.

While the above is common in other vehicle routing optimizers, the optimization framework in this invention implements multiple algorithms (called movers as they move the solution from one to another). Each mover executes a specific sub-routine to either explore the solution space (potentially resulting in a better solution in the future) or exploit the current solution to obtain an improved solution which selects a new route in a pre-configured way, for example by changing a parameter (e.g., vehicle type/usage, load, number of items) or adding/removing/switching a location into/out from the initial route. The selection of these movers is dynamic based on the historical performance of the movers in obtaining a better solution for the given problem. This framework hence exploits the no-free-lunch theorem of algorithms which roughly states that no one algorithm is better than all others in solving a given problem—in other words, all algorithms have their own strengths and weaknesses depending on the properties of the problem at hand (e.g. type of constraints, problem size, etc). Moreover, this adaptive selection is also able to shift the behaviour of the optimizer from exploratory at the initial phases to exploitation towards the end of the search duration. The exploratory phase is crucial as it allows the optimizer to escape being trapped in a local optimum prematurely.

In other words, the optimizer is capable to adaptively and dynamically select the appropriate algorithm to solve different variants of the VRP. This design also allows for extendibility of the optimizer as additional movers can be implemented to further enhance its capabilities. Coupled with the adaptive selection capabilities, implementing additional movers will not worsen the optimizer since if a new mover's performance is poor given the problem to be solved, it will eventually not be selected in subsequent iterations.

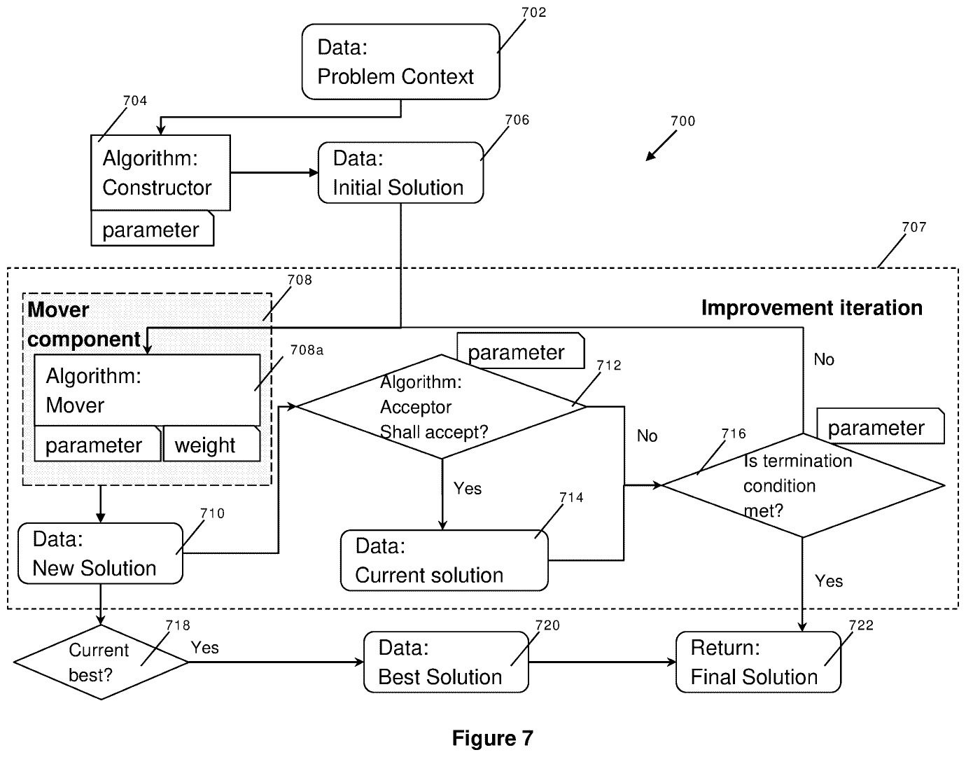

FIG. 7 shows a flow chart 700 illustrating a process of an iterative search flow used for adaptively identifying an optimal model to select a route to a location according to an embodiment of the present disclosure.

In step 702, the input that contains the data for entities modelling, such as problem context data, and parameters, such as the constructor algorithms (e.g., greedy insertion, ant-colony system) to use and the weights, are read. In one embodiment, in this step, a routing characteristic is also determined based on the input. In step 704, a step of retrieving the data is carried out. In step 706, a construction of an initial solution (first model) is carried out using one of the constructor algorithms based on the routing characteristic and the variant of the VRP to be solved determined from the input. This way, the design for this optimizer allows an adaptive vehicle routing optimization where the optimizer is able to solve It is possible that multiple constructor algorithms may be used to obtain multiple initial solution (first models), and a step of selecting one of the optimal initial solution for use in the subsequent processes is carried out.

With the initial optimal solution, the optimizer performs an iterative search flow 707, where multiple iterations through different search algorithms (moving algorithms) are conducted to improve the solution. Each iteration is one improvement iteration. Finally, the best solution found so far after a pre-determined amount of time specified by the user is returned and output.

In particular, in each iteration of the iterative search flow 707, step 708a is carried out where a moving algorithm from a mover component 708 is selected from multiple algorithms based on weights and in step 710, the moving algorithm is applied to the current solution (for first iteration, the initial solution is the current solution) to generate a new solution. In step 712, an acceptor algorithm is applied to the new solution to determine whether the solution is to be accepted. Without a loss of generality, it is possible that the acceptor algorithm will accept the new solution based on other conditions even when the effectiveness of the new solution in minimizing the expenses parameter is not better than that of the current solution, in order to widen the search space.

If it is to be accepted, step 714 is carried out; otherwise, step 716 is carried out. In step 714, the new solution is set as the current solution. In step 716, it is determined if the termination condition such as the total number of iterations (total number of new solutions generated), or the total processing time, is met. If the termination condition is met (e.g., the total number of iterations or the total processing time exceed certain threshold number of iterations or threshold processing time), step 722 is carried out. If the termination condition is not met, another improvement iteration is carried out and the steps 708a-714 are repeated, using another mover component which is selected based on weights or updated weights.

In step 718, a step of checking the new solution generated in step 710 against the best solution currently stored in a database (not shown) is carried out to determine if the new solution is better than the best solution (for first iteration, the new solution is set as the best solution), and in step 720, the best solution is identified and selected, and the record of the best solution stored in the database is updated. The comparison may be based on their effectiveness in minimizing the routing expense parameter, the best solution is selected from one that has a higher effectiveness in minimizing the routing expense parameter. In step 722, the iteration is terminated and the best solution stored in the database set as the final solution. The final solution is then returned and output, and the process may end.

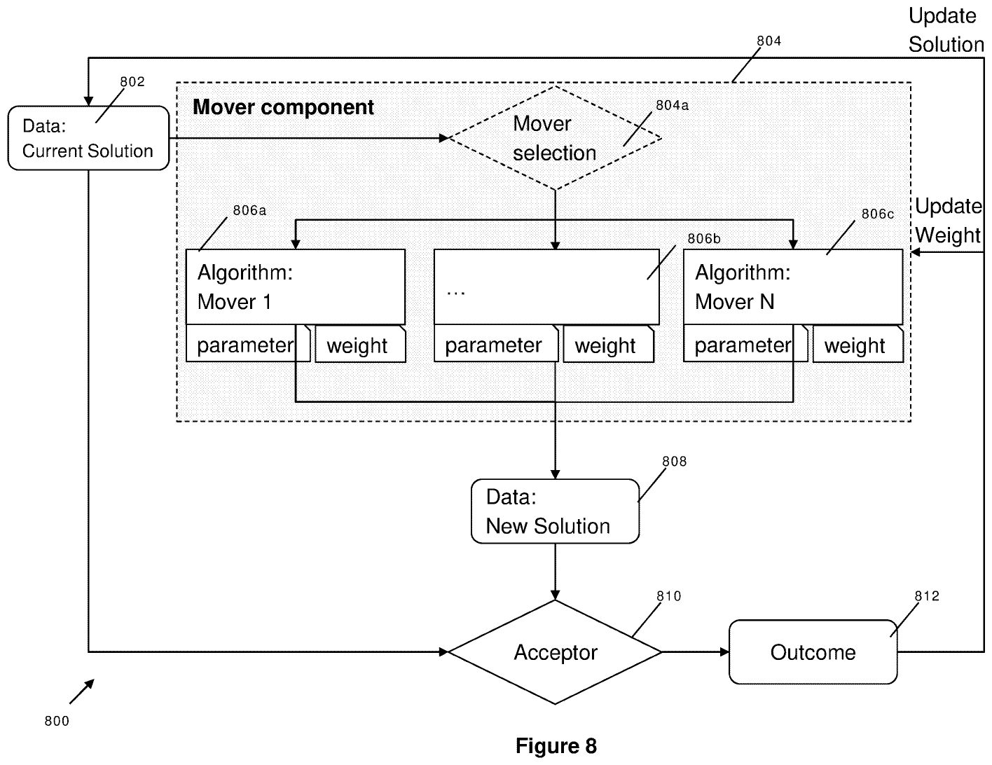

FIG. 8 shows a flow chart illustrating a process of an adaptive large neighbourhood search flow used adaptively for identifying an optimal model to select a route to a location according to an embodiment of the present disclosure. The adaptive large neighbourhood search is applied in step 708a by a mover component, e.g., mover component 708, such that a moving algorithm is chosen and applied based on weights. In particular. the mover component contains multiple moving algorithms, each moving algorithm comprising parameters and an assigned weight, capable of receiving an initial solution as an input and returning a new solution as an output, as described in FIG. 7. In each improvement iteration, a moving algorithm is dynamically chosen based on weights, for example the moving algorithm which has the highest weight will be selected to generate a new solution from the current solution The weight distribution of all the moving algorithm candidates are dynamically updated by this adaptive large neighbourhood search flow.

In step 802. a current solution is generated, for example a conductor algorithm or a moving algorithm implemented by a mover component 804 after an improvement iteration. The mover component 804 comprises a mover selection 804a configured to select one of multiple moving algorithms 806a-806c based on their weights. In step 808, a new solution is generated (and new route with different parameters) based on the selected moving algorithm.

In step 808, an acceptor algorithm is applied to the new solution to determine whether the solution is to be accepted. If the new solution is to be accepted, in step 812, the new solution will be set as the current solution for subsequent improvement iteration step. Additionally, the weight of the selected moving algorithm will be updated. If the new solution is rejected, for example if the new solution has a lower effectiveness than the current solution, in step 812, the new solution will not be asset as the current solution, and the weight of the selected moving algorithm will remain the same or be decreased. Without a loss of generality, it is possible that the acceptor algorithm will accept the new solution based on other conditions even when the effectiveness of the new solution in minimizing the expenses parameter is not better than that of the current solution (e.g., simulated annealing acceptor).

The updated weights then determine a new set of selection probabilities for the moving algorithms to be selected in the next improvement iteration. Such adaptive nature of the selection weights, along with a large library of movers (moving algorithms), make up the adaptive large neighbourhood search flow and framework.

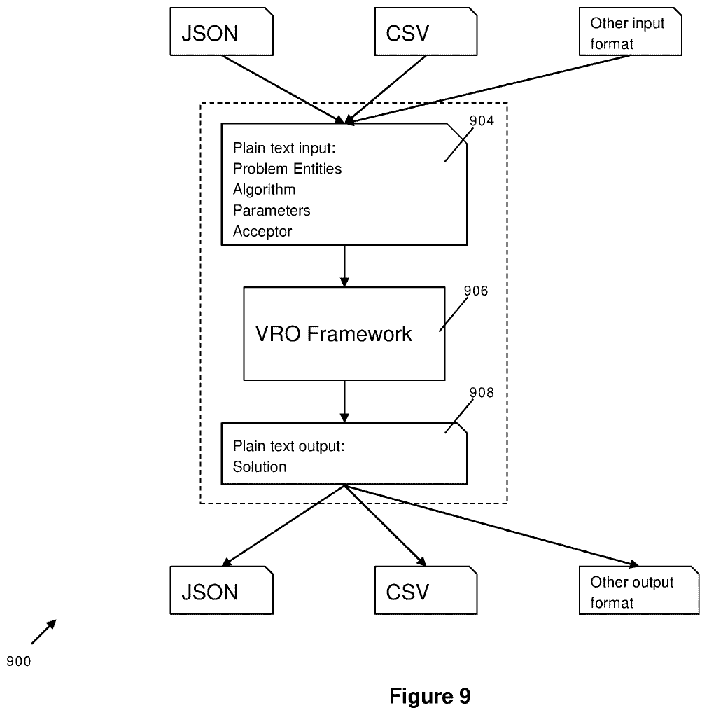

Externally, a general interface is provided to receive VRO input regarding algorithm configuration dynamically, such as the algorithms list, and the individual weight and its parameter. FIG. 9 shows a flow chart 900 illustrating a vehicle routing optimizer and external interfaces for adaptively identifying an optimal model to select a route to a location according to an embodiment of the present disclosure. The interface defines the VRO input 904 and output 906 in plain text format, so that the input 904 and output 908 can be converted with other text formats, such as JSON, CSV. This further brings a flexibility to the framework to adopt with any other formats. The VRO framework 906 performs the operations described in FIG. 7 or FIG. 8.

With a clearly defined external interface, the optimizer as designed can also act as the core optimizer module in a larger routing, inventory, or demand management software. The input interface can accept input from other data processing sources, while the output interface can provide the solution for visualization or post-optimization by ground operations teams.

The design in this disclosure also achieves high performance, which means that it can obtain high quality solutions (as close to the optimal solution as possible)—within a reasonable time (e.g., specified by the user based on the use case) and resources (CPU and Memory). This is enabled by custom implementation of data structures and algorithms which greatly improves the efficiency of frequently-called subroutines in the movers.

A typical sequence container for the nodes has a linear runtime complexity (meaning the running time for operations to the route increases linearly as the size of the route increases), while the custom data structure implemented in this present disclosure has a constant runtime complexity (meaning the running time for route operations does not increase with the size of the route). This allows the optimizer to handle large-scale problems as the run time of the subroutines involved does not increase with the size of the problem. Moreover, the custom Route data structure also encapsulates information on constraints and accumulated values (e.g., time, distance, capacity) along the sequence of nodes visited with little overhead.

Referring to FIG. 6, with the custom linked-list implementation, Route data 600 can be manipulated by inserting or removing a Visit/Node from the Visit chain/sequence respectively. The route manipulation process may be carried out This allows the operation to have a constant O(1) runtime complexity regardless of how long the Visit chain is. As the search heuristic can frequently calls on insertion and removal operations on the Routes to explore different sequences of nodes to be visited, this speeds up the search heuristics. Operation to change the vehicle type used to serve the route also has a constant O(1) runtime as it simply involves changing the VehicleType information in the Route.

The Visit structure 604a-604d containing information on the accumulated quantities up to the node to be visited can be used to check if an insertion is potentially feasible in terms of the quantity limit. For example, if it is determined that the weight (load) up to the node visited already exceeds the weight limit for the vehicle (as stored in the VehicleType field 602), or the processing time has exceeded the threshold runtime, then there is no need to attempt inserting any further Visit after that particular Visit. This again helps to speed up the search heuristics without actually implementing additional data structures for each heuristics.

Updating the accumulated quantities is also fast since it simply requires the information on the node to be visited and/or the Visit before and after that Visit (the required quantity information is stored in ProblemContext). As long as the state of Visits are updated, there is no need to iterate through the entire Route to update the accumulated quantities—instead, iterating through the Visits from the point of change is sufficient.

Finally, the map 606 that translates Node to the corresponding Visit structure ensures that searching for the respective Visit for a given Node also has a constant O(1) runtime complexity, as there is no need to iterate through the Visit structures to find which Visit corresponds to the Node of interest as in a typical linked list data structure. This map is updated accordingly as Visits are inserted or removed.

In other words, having a custom specialized data structure and algorithm for Route enables the optimizer to have a constant O(1) runtime complexity for Route manipulation, which greatly speeds up the overall search algorithms and allows it to obtain a high-quality solution within a reasonable time. This allows the optimizer to be scalable, possibly solving very large-scale problems.

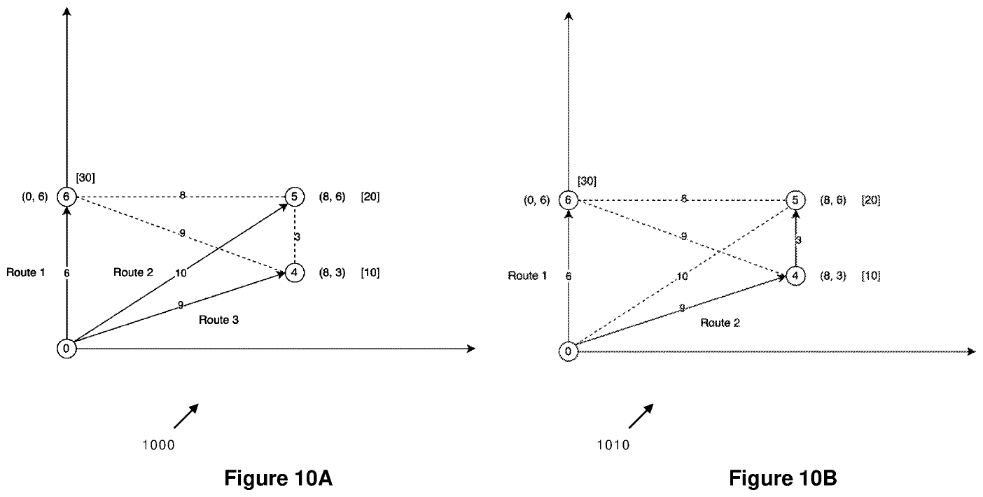

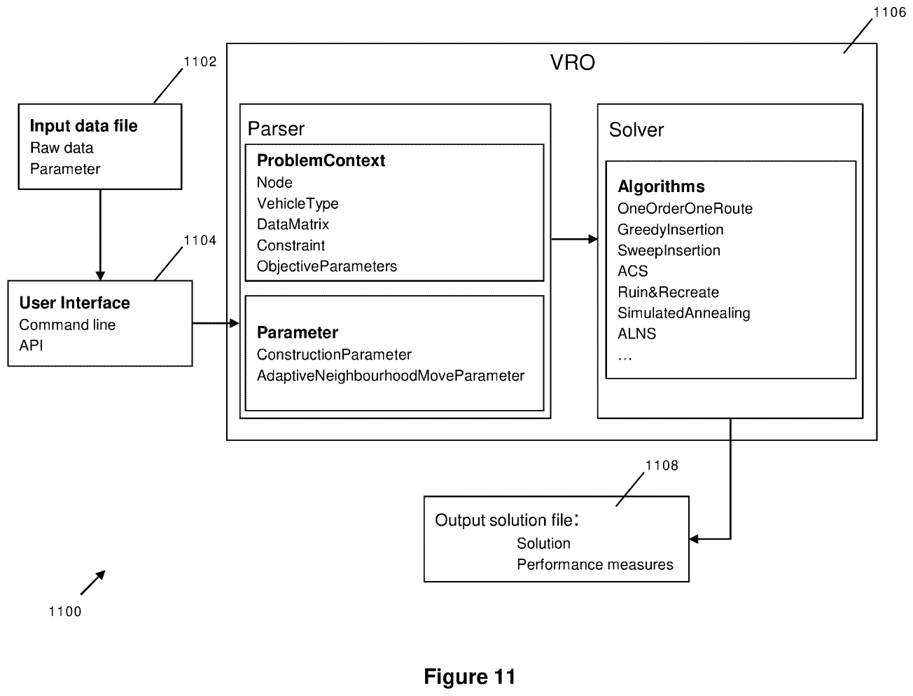

FIG. 10A shows a diagram 1000 illustrating locations corresponding to Capacitated vehicle routing problem with pickups and deliveries (CVRPPD) problem and an initial model (solution) to select a route(s) to the locations according to an embodiment of the present disclosure. In this embodiment, there are three packages to picked up at depot denoted as Node 0 and delivered to different locations denoted as Nodes 4, 5, 6. The location coordinates are represented by a pair of scalars in parentheses while the loads to be unloaded upon delivery are denoted by the scalars (e.g., [10], [20], [30]), next to their linkages. When identifying an optimal model to select a route, two types of vehicles with different capacities/capabilities and usage costs are input and modelled. A model capable of identifying a route connecting all the three locations with minimal possible routing expense/cost (e.g., vehicle usage and transportation (travel time) costs) to dispatch the vehicles to deliver the packages can be obtained while the capacity and pick-up delivery constraints are observed and an accumulated load/time/distance of the vehicles are constantly checked if it exceeds the accumulation threshold.

For example, a possible initial solution (construction algorithm) is identified which assigns each node to a vehicle, thus three routes (Route 1, Route 2, Route 3) are selected. In Route 1, Vehicle 1 (not shown) is assigned to visit Node 6; in Route 2, Vehicle 2 (not shown) is assigned to visit Node 5; and Vehicle 3 (not shown) is assigned to visit Node 4. With this solution, the route expense parameter in term of the total load of each vehicle is within their respective vehicle capacities but the route expense parameter in term of the total distance travelled by all vehicles is 25 (6+10+9=25).

A mover algorithm (improvement iteration) can be used to further improve the route(s), for example, by removing Node 4 from Route 3 and insert Node 4 into Route 2. FIG. 10B illustrates shows a diagram 1010 illustrating an improved solution to select a route(s) to the locations from FIG. 10A. With the removal of Node 4 and thus Route 3 and the addition of Node 4 into Route 2, there will be two routes. Route 1 is unchanged, and Vehicle 1 is assigned to visit Node 6 in Route 1; whereas in Route 2, Vehicle 2 is now assigned to visit Node 4 followed by Node 5. The sequence of node visits in Route 2 is selected such that the routing expenses parameter in term of the distance travelled in the route is smaller. In particular, if the visit sequence is Node 5 followed by Node 4, the distance travelled in the route is 13 (10+3=13); but if the visit sequence is Node 4 followed by Node 5, the distance travelled in the route becomes 12 (9+3). With this improved solution, the route expense parameter in term of the total load of each vehicle is still within their respective vehicle capacities (unchanged), but the route expense parameter in term of the total distance travelled by all vehicles is now 18 (6+12) and also the route expense parameter in term of the number of vehicles is lower. The improved solution is more effective in minimizing the route expense parameter and selecting better routes to the locations than the initial model as the total distance is lower (and also uses less vehicle), while still meeting all the requirements and constraints.

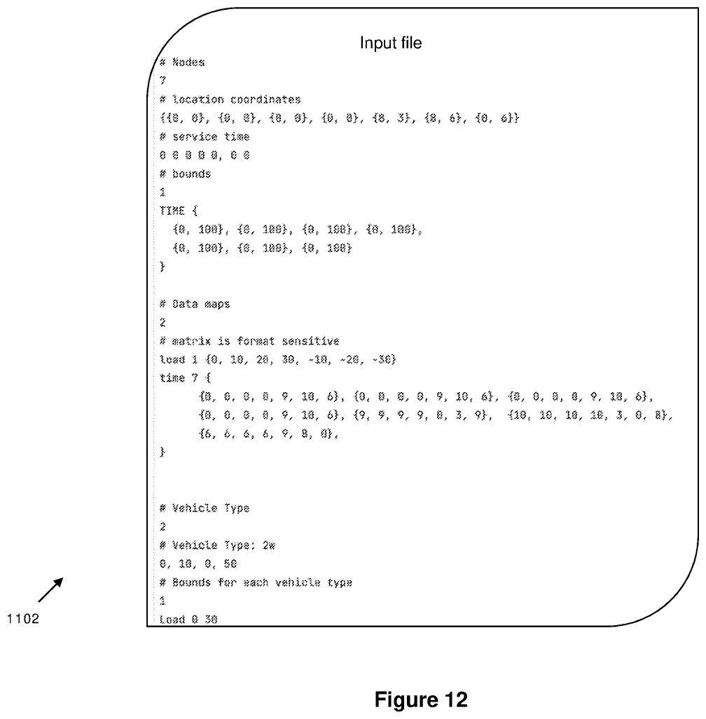

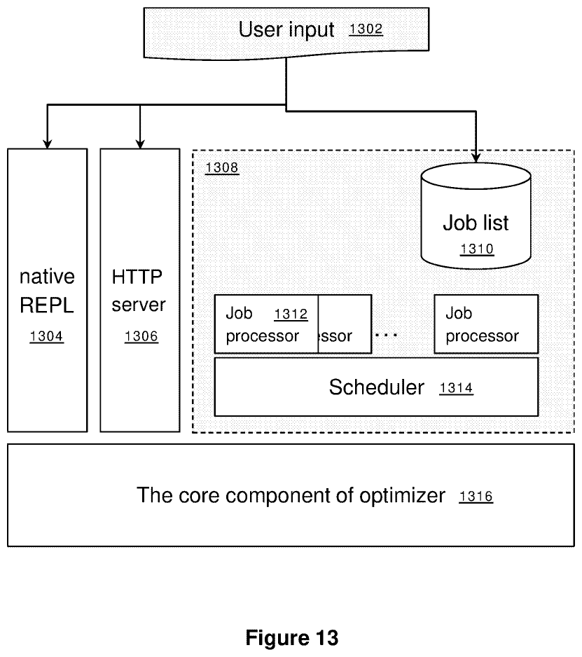

FIG. 11 shows an exemplary implementation of a vehicle routing optimizer according to an embodiment of the present disclosure. The implementation first starts with preparation of input data files 1102 that includes the raw input data such as node-related data (node index, location coordinates, load, etc.), VehicleType data (type index, number of available vehicles, capacity, etc.), data matrix (ETA/distance matrix). constraint (time AccumulationConstraint, load AccumulationConstraint and pickup-delivery PrecedenceConstraint), objective parameters (weightages of vehicle usage and travel time costs in the objective function). FIG. 12 shows a sample format of the input data file 1102 provided for the users so that they can simply input or revise the data according to respective use cases.

Once the input data file 1102 is ready, the users can either use the input file with C++ binaries in the command line tool or API provided by the Optimiser user interface 1104. After that, the input file will be processed and parsed to obtain the required ProblemContext and Parameter data inside the Optimiser 1106. With the data, the Optimiser 1106 will perform the calculation with specified solution algorithms to identify an optimal model to select a route and solve the above problem and return the optimal model (final solution) together with performance metrics (e.g., score, routing expense parameter value, effectiveness in minimizing routing expense parameter) in the output solution file 1108.

If additional time windows are imposed on the above package delivery, meaning the packages should be delivered within certain feasible time windows specified by customers, time window constraints can be added in the modeling with Constraint entity. The problem then becomes a capacitated VRP with pickup and deliveries and time windows (CVRPPDTW) problem. The implementation flow remains the same after including time window constraints, which demonstrates the flexibility of current design to address different VRP variants. Table 1 illustrates example sources for the input data.

TABLE 1
Example input data and sources

| Input Data | Source |
|---|---|
| Delivery location nodes and coordinates | Order data |
| Delivery service time | Historical service time |
| Delivery load | Order data |
| Delivery time window | Order data and/or service levels and/or |
| | selected time windows |
| Travel times between nodes | Real-time travel data from a mapping provider |
| | or historical travel time data |
| Vehicle capacity | Vehicle data |
| Objective function parameters | Business decision and vehicle operating |
| | costs |

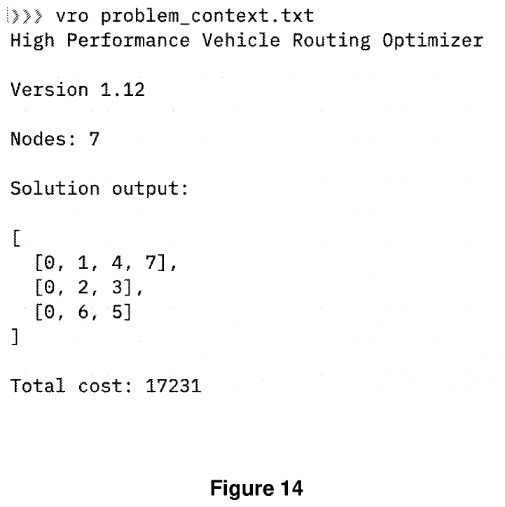

FIG. 13 shows exemplary interface layers implemented for a system for adaptively identifying an optimal model to select a route to a location according to an embodiment of the present disclosure. A flexible infrastructure is designed and implemented for this high performance vehicle routing optimizer. The infrastructure includes three different interface layers 1304, 1306, 1308.

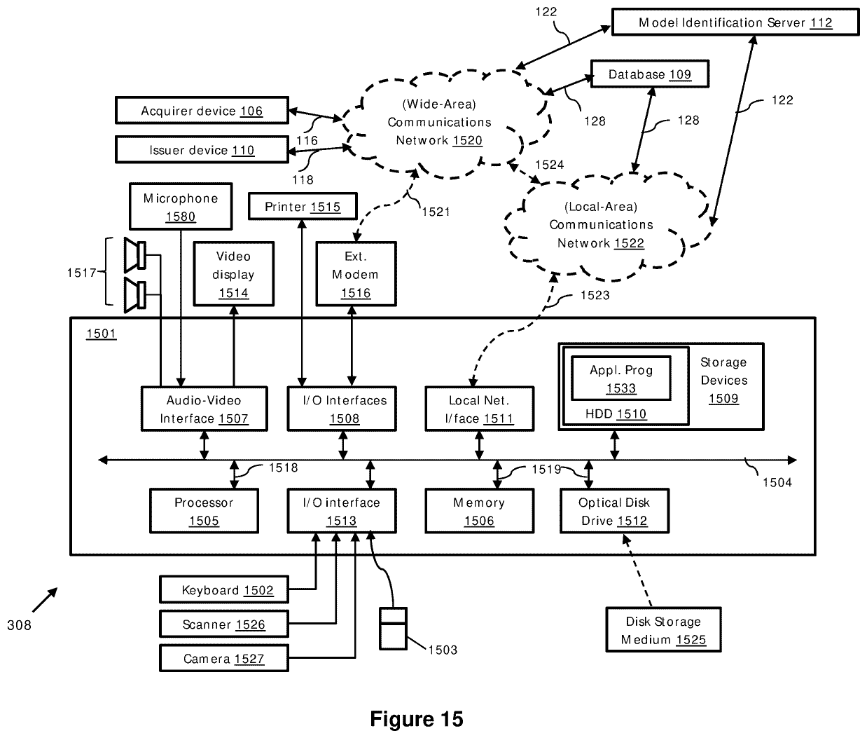

The first layer of interface is the native REPL (Read-eval-print loop) 1304 that can be deployed on the end user's environment. It is using the native programming language interface to provide direct interaction between the user input 1302 (or 1102 as exemplified in FIG. 12) and the optimizer 1316. FIG. 14 shows a native read-evaluate-print loop (REPL) interface sample according to an embodiment of the present disclosure. End user executes the native interface called VRO (vehicle routing optimizer), and obtains the solving result on the console directly.

The second layer of interface is the synchronized HTTP interface 1306, through which the user sends the problem context (as exemplified in FIG. 12) in a predefined payload to the HTTP server. This layer 1306 supports a limited input size and limited solving time as the HTTP communication might have a timeout limit between the end user and the interface. For instance, a limit of input size 100 nodes, and a limited solving time of 5 seconds will be applied on this interface.

The third layer of the interface is an asynchronized on-demand cloud service 1308, where the user submits the input file 1302 (or 1102 as exemplified in FIG. 12) as a job request to the cloud service 1308. The service 1308 will process the user input, and store the input into a job list/database 1310. The Scheduler 1314 will schedule a pre-defined time to fetch the input file 1302 from job list 1310, and solve the problem using one or more job processors (e.g., processor 1312). This interface supports larger input size and longer solving time. For instance, the input size can be increased to more than 1000 nodes, and the solving time can be increased to more than 30 seconds. In this high performance vehicle routing optimizer infrastructure design, each layer can be easily switched on and off, and even packaged separately. This provides flexibility and scalability to infrastructure implementation.

FIG. 15 shows a schematic diagram of a general purpose computer system 1500 upon which the coordination server 108 of FIG. 1 can be practiced. The computer system 1500 includes: a computer module 1501, input devices such as a keyboard 1502, a mouse pointer device 1503, a scanner 1526, a camera 1527, and a microphone 1580; and output devices including a printer 1515, a display device 1514 and loudspeakers 1517. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The input and output devices may be used by an operator who is interacting with the coordination server 108. For example, the printer 1515 may be used to print reports relating to the status of the coordination server 108.

The coordination server 108 uses the communications network 1520 to communicate with the provider device 104, the requestor device 102, the model identification server 112 and the database 188 to receive commands and data. The coordination server 108 also uses the communications network 1520 to communicate with the provider device 104, the requestor device 102, the model identification server 112 and the database 188 to send notification messages or transaction/location/route/vehicle/model data.

The computer module 1501 typically includes at least one processor unit 1505, and at least one memory unit 1506. For example, the memory unit 1506 may have semiconductor random access memory (RAM) and semiconductor read only memory (ROM). The computer module 1501 also includes a number of input/output (I/O) interfaces including: an audio-video interface 1507 that couples to the video display 1514, loudspeakers 1517 and microphone 1580; an I/O interface 1513 that couples to the keyboard 1502, mouse 1503, scanner 1526, camera 1527 and optionally a joystick or other human interface device (not illustrated); and an interface 1508 for the external modem 1516 and printer 1515. In some implementations, the modem 1516 may be incorporated within the computer module 1501, for example within the interface 1508. The computer module 1501 also has a local network interface 1511. which permits coupling of the computer system 1500 via a connection 223 to a local-area communications network 1522, known as a Local Area Network (LAN). As illustrated in FIG. 9, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 1502.11 wireless arrangement; however, numerous other types of interfaces may be practiced for the interface 1511.

The I/O interfaces 1508 and 1513 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the coordination server 108.

The components 1505 to 1513 of the computer module 1501 typically communicate via an interconnected bus 1504 and in a manner that results in a conventional mode of operation of a computer system known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple Mac™ or like computer systems.

The methods of operating the coordination server 108, as shown in the processes of FIGS. 3, 6-9 and 11, may be implemented as one or more software application programs 1533 executable within the coordination server 108. In particular, the steps of the processes shown in FIGS. 3, 6-9 and 11 are effected by instructions 1531 (see FIG. 16) in the software (i.e., computer program codes) 1533 that are carried out within the coordination server 108. The software instructions 1531 may be formed as one or more code modules, each for performing one or more particular tasks. The software may also be divided into two separate parts, in which a first part and the corresponding code modules performs the operation of the coordination server 108 and a second part and the corresponding code modules manages the API and corresponding user interfaces in the provider device 104, the requestor device 102, and on the display 1514. In other words, the second part of the software manages the interaction between (a) the first part and (b) any one of the provider device 104, the requestor device 102, and the operator of the server 108.

The software may be stored in a computer readable medium, including the storage devices described below, for example. The software is loaded into the coordination server 108 from the computer readable medium, and then executed by the computer system 1500. A computer readable medium having such software or computer program recorded on the computer readable medium is a computer program product. The use of the computer program product in the coordination server 108 preferably effects an advantageous apparatus for receiving/transmitting data including location data, vehicle data, route data, model data, routing constraint data (or data and parameters input to ProblemContext entity 404) and/or transaction data for the adaptive optimal model identification and route selection/generation processes performed by the model identification server 112.

The software (i.e., computer program codes) 1533 is typically stored in the HDD 1510 or the memory 1506. The software 1533 is loaded into the computer system 1500 from a computer readable medium (e.g., the memory 1506), and executed by the processor 1505. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the coordination server 108 preferably effects an apparatus for receiving/transmitting data including location data, vehicle data, route data, model data, routing constraint data (or data and parameters input to ProblemContext entity 404) and/or transaction data used for the adaptive optimal model identification and route selection/generation processes performed by the model identification server 112.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the coordination server 108 from other computer readable media. Computer readable storage media refers to any non-transitory tangible storage medium that provides recorded instructions and/or data to the coordination server 108 for execution and/or processing by the processor 1505. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more API of the coordination server 108 with associated graphical user interfaces (GUIs) to be rendered or otherwise represented upon the display 1514 or the display of the provider device 104 and the requestor device 102. Through manipulation of typically the keyboard 1502 and the mouse 1503, an operator of the server 110 and the application may manipulate the interface in a functionally adaptable manner to provide controlling commands and/or input to the applications associated with the GUI(s). Similarly, on the provider device 104 and the requestor device 102, a user of those devices 102, 104 manipulate the input devices (e.g., touch screen, keyboard, mouse, etc.) of those devices 102, 104 in a functionally adaptable manner to provide controlling commands and/or input to the applications associated with the GUI(s). Other forms of functionally adaptable user interfaces may also be implemented, such as an audio interface utilizing speech prompts output via the loudspeakers 1517 and user voice commands input via the microphone 1580. These other forms of functionally adaptable user interfaces may also be implemented on the provider device 104 and the requestor device 102.

FIG. 16 is a detailed schematic block diagram of the processor 1505 and a “memory” 1534. The memory 1534 represents a logical aggregation of all the memory modules (including the HDD 1509 and semiconductor memory 1506) that can be accessed by the computer module 1501 in FIG. 15.

When the computer module 1501 is initially powered up, a power-on self-test (POST) program 1550 executes. The POST program 1550 is typically stored in a ROM 1549 of the semiconductor memory 1506 of FIG. 15. A hardware device such as the ROM 1549 storing software is sometimes referred to as firmware. The POST program 1550 examines hardware within the computer module 1501 to ensure proper functioning and typically checks the processor 1505, the memory 1534 (609, 1506), and a basic input-output systems software (BIOS) module 1551, also typically stored in the ROM 1549, for correct operation. Once the POST program 1550 has run successfully, the BIOS 1551 activates the hard disk drive 1510 of FIG. 16. Activation of the hard disk drive 1510 causes a bootstrap loader program 1552 that is resident on the hard disk drive 1510 to execute via the processor 1505. This loads an operating system 1553 into the RAM memory 1506, upon which the operating system 1553 commences operation. The operating system 1553 is a system level application, executable by the processor 1505, to fulfil various high level functions, including processor management, memory management, device management, storage management, software application interface, and generic user interface.

The operating system 1553 manages the memory 1534 (609, 1506) to ensure that each process or application running on the computer module 1501 has sufficient memory in which to execute without colliding with memory allocated to another process. Furthermore, the different types of memory available in the server 108 of FIG. 15 must be used properly so that each process can run effectively. Accordingly, the aggregated memory 1534 is not intended to illustrate how particular segments of memory are allocated (unless otherwise stated), but rather to provide a general view of the memory accessible by the server 108 and how such is used.

As shown in FIG. 16, the processor 1505 includes a number of functional modules including a control unit 1539, an arithmetic logic unit (ALU) 1540, and a local or internal memory 1548, sometimes called a cache memory. The cache memory 1548 typically includes a number of storage registers 1544-1546 in a register section. One or more internal busses 1541 functionally interconnect these functional modules. The processor 1505 typically also has one or more interfaces 1542 for communicating with external devices via the system bus 1504, using a connection 1518. The memory 1534 is coupled to the bus 1504 using a connection 1519.

The application program 1533 includes a sequence of instructions 1531 that may include conditional branch and loop instructions. The program 1533 may also include data 1532 which is used in execution of the program 233. The instructions 1531 and the data 1532 are stored in memory locations 1528, 1529, 1530 and 1535, 1536, 1537, respectively. Depending upon the relative size of the instructions 1531 and the memory locations 1528-630, a particular instruction may be stored in a single memory location as depicted by the instruction shown in the memory location 1530. Alternately, an instruction may be segmented into a number of parts each of which is stored in a separate memory location, as depicted by the instruction segments shown in the memory locations 1528 and 1529.

In general, the processor 1505 is given a set of instructions which are executed therein. The processor 1505 waits for a subsequent input, to which the processor 1505 reacts to by executing another set of instructions. Each input may be provided from one or more of a number of sources, including data generated by one or more of the input devices 1502, 1503, data received from an external source across one of the networks 1520, 1502, data retrieved from one of the storage devices 1506, 1509 or data retrieved from a storage medium 1525 inserted into the corresponding reader 1512, all depicted in FIG. 15. The execution of a set of the instructions may in some cases result in output of data. Execution may also involve storing data or variables to the memory 1534.

The disclosed association management and payment initiation arrangements use input variables 1554, which are stored in the memory 1534 in corresponding memory locations 1555, 1556, 1557. The association management and payment initiation arrangements produce output variables 1561, which are stored in the memory 1534 in corresponding memory locations 1562, 1563, 1564. Intermediate variables 258 may be stored in memory locations 1559, 1560, 1566 and 1567.

Referring to the processor 1505 of FIG. 15, the registers 1544, 1545, 1546, the arithmetic logic unit (ALU) 1540, and the control unit 1539 work together to perform sequences of micro-operations needed to perform “fetch, decode, and execute” cycles for every instruction in the instruction set making up the program 1533. Each fetch, decode, and execute cycle comprises: a fetch operation, which fetches or reads an instruction 1531 from a memory location 1528, 1529, 1530; a decode operation in which the control unit 1539 determines which instruction has been fetched; and an execute operation in which the control unit 1539 and/or the ALU 1540 execute the instruction.

Thereafter, a further fetch, decode, and execute cycle for the next instruction may be executed. Similarly, a store cycle may be performed by which the control unit 1539 stores or writes a value to a memory location 1532.

Each step or sub-process in the processes of FIGS. 3, 6-9 and 11 is associated with one or more segments of the program 1533 and is performed by the register section 1544, 1545, 1547, the ALU 1540, and the control unit 1539 in the processor 1505 working together to perform the fetch, decode, and execute cycles for every instruction in the instruction set for the noted segments of the program 1533.

It is to be understood that the structural context of the coordination server 108 is presented merely by way of example. Therefore, in some arrangements, one or more features of the coordination server 108 may be omitted. Also, in some arrangements, one or more features of the coordination server 108 may be combined. Additionally, in some arrangements, one or more features of the coordination server 108 may be split into one or more component parts.

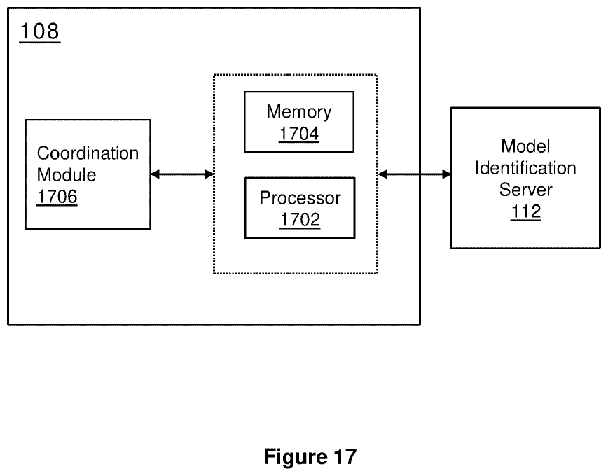

FIG. 17 shows an alternative computer device to implement the coordination server 108 of FIG. 1 (i.e., the computer system 1500). In the alternative implementation, the coordination server 108 may be generally described as a physical device comprising at least one processor 1702 and at least one memory 1704 including computer program codes. The at least one memory 1704 and the computer program codes are configured to, with the at least one processor 1702, cause the coordination server 108 to facilitate the operations described in the processes of FIGS. 3, 6-9 and 11. The coordination server 108 may also include a coordination module 1706. The memory 1704 stores computer program code that the processor 1702 compiles to have each of the modules performs their respective functions.

With reference to FIG. 1, the coordination module 1706 performs the function of communicating with the requestor device 102 and the provider device 104; and the acquirer server 106 and the issuer server 110 to respectively receive and transmit a transaction and location/route/vehicle/model data. Further, the coordination module 1706 may provide data and information such as location data, vehicle data, route data, model data, routing constraint data (or data and parameters input to ProblemContext entity 404) and transaction data used for the adaptive optimal model identification and route selection/generation processes performed by the model identification server 112.

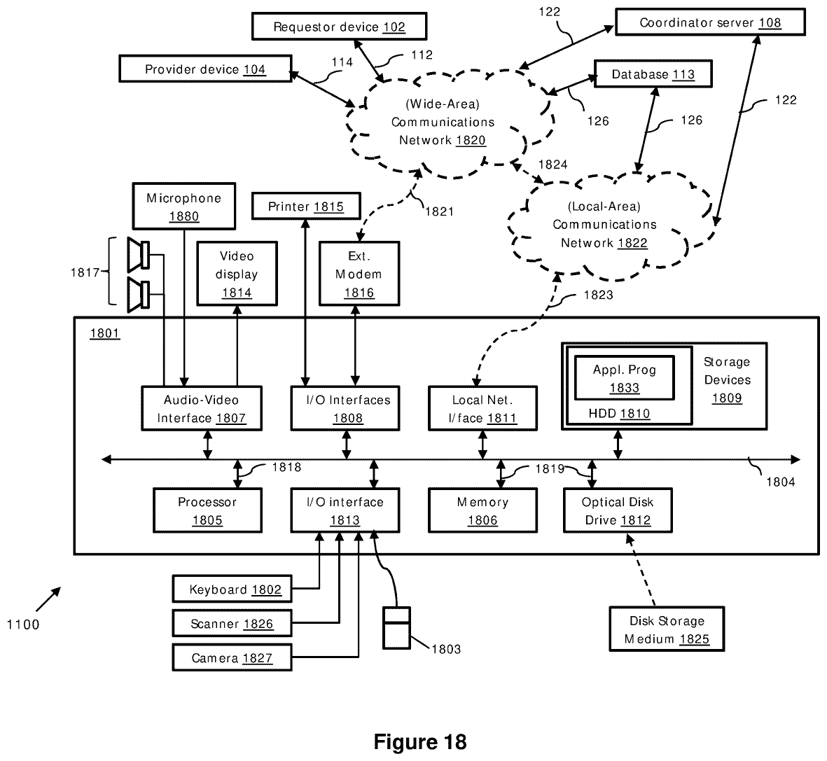

FIGS. 18 shows a schematic diagram of a general purpose computer system 1800 upon which the model identification server 112 of FIG. 1 can be practiced. The computer system 1800 includes: a computer module 1801, input devices such as a keyboard 1802, a mouse pointer device 1803, a scanner 1826, a camera 1827, and a microphone 1880; and output devices including a printer 1815, a display device 1814 and loudspeakers 1817. An external Modulator-Demodulator (Modem) transceiver device 1816 may be used by the computer module 1801 for communicating to and from a communications network 1820 via a connection 1821. The communications network 1820 may be a wide-area network (WAN), such as the Internet, a cellular telecommunications network, or a private WAN. Where the connection 1821 is a telephone line, the modem 1816 may be a traditional “dial-up” modem. Alternatively, where the connection 1821 is a high capacity (e.g., cable) connection, the modem 1813 may be a broadband modem. A wireless modem may also be used for wireless connection to the communications network 1820.

The input and output devices may be used by an operator who is interacting with the model identification server 112. For example, the printer 1815 may be used to print reports relating to the status of the model identification server 112.

The model identification server 112 uses the communications network 1820 to communicate with the provider device 104, the requestor device 102, the coordination server 108 and the model identification database 113 to receive commands and data. The model identification server 112 also uses the communications network 1820 to communicate with the provider device 104, the requestor device 102, the coordination server 112 and the database 188 to send notification messages or transaction/location/route/vehicle/model data.

The computer module 1801 typically includes at least one processor unit 1805, and at least one memory unit 1806. For example, the memory unit 1806 may have semiconductor random access memory (RAM) and semiconductor read only memory (ROM). The computer module 1801 also includes a number of input/output (I/O) interfaces including: an audio-video interface 1807 that couples to the video display 1814, loudspeakers 1817 and microphone 1880; an I/O interface 1813 that couples to the keyboard 1802, mouse 1803, scanner 1826, camera 1827 and optionally a joystick or other human interface device (not illustrated); and an interface 1808 for the external modem 1816 and printer 1815. In some implementations, the modem 1816 may be incorporated within the computer module 1801, for example within the interface 1808. The computer module 1801 also has a local network interface 1811, which permits coupling of the computer system 1800 via a connection 1823 to a local-area communications network 1822, known as a Local Area Network (LAN). As illustrated in FIG. 18, the local communications network 1822 may also couple to the wide network 1820 via a connection 1824, which would typically include a so-called “firewall” device or device of similar functionality. The local network interface 1811 may comprise an Ethernet circuit card, a Bluetooth® wireless arrangement or an IEEE 802.11 wireless arrangement; however, numerous other types of interfaces may be practiced for the interface 1811.

The I/O interfaces 1808 and 1813 may afford either or both of serial and parallel connectivity, the former typically being implemented according to the Universal Serial Bus (USB) standards and having corresponding USB connectors (not illustrated). Storage devices 1809 are provided and typically include a hard disk drive (HDD) 1810. Other storage devices such as a floppy disk drive and a magnetic tape drive (not illustrated) may also be used. An optical disk drive 1812 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the model identification server 112.

The components 1805 to 1813 of the computer module 1801 typically communicate via an interconnected bus 1804 and in a manner that results in a conventional mode of operation of a computer system known to those in the relevant art. For example, the processor 1805 is coupled to the system bus 1804 using a connection 1818. Likewise, the memory 1806 and optical disk drive 1812 are coupled to the system bus 1804 by connections 1819. Examples of computers on which the described arrangements can be practised include IBM-PC's and compatibles, Sun Sparcstations, Apple Mac™ or like computer systems.

The methods of operating the model identification server 112, as shown in the processes of FIGS. 3, 6-9 and 11, may be implemented as one or more software application programs 1833 executable within the model identification server 112. In particular, the steps of the processes shown in FIGS. 3, 6-9 and 11 are effected by instructions (see corresponding component 1531 in FIG. 16) in the software (i.e., computer program codes) 1833 that are carried out within the model identification server 112. The software instructions 1531 may be formed as one or more code modules, each for performing one or more particular tasks. The software may also be divided into two separate parts, in which a first part and the corresponding code modules performs the operation of the model identification server 112 and a second part and the corresponding code modules manages the API and corresponding user interfaces in the provider device 104, the requestor device 102, and on the display 1814. In other words, the second part of the software manages the interaction between (a) the first part and (b) any one of the provider device 104, the requestor device 102, and the operator of the server 112.

The software may be stored in a computer readable medium, including the storage devices described below, for example. The software is loaded into the model identification server 112 from the computer readable medium, and then executed by the computer system 1800. A computer readable medium having such software or computer program recorded on the computer readable medium is a computer program product. The use of the computer program product in the model identification server 112 preferably effects an advantageous apparatus for adaptively identifying an optimal model to select a route to a location.

The software (i.e., computer program codes) 1833 is typically stored in the HDD 1810 or the memory 1806. The software 1833 is loaded into the computer system 1800 from a computer readable medium (e.g., the memory 1806). and executed by the processor 1805. Thus, for example, the software 1833 may be stored on an optically readable disk storage medium (e.g., CD-ROM) 1825 that is read by the optical disk drive 1812. A computer readable medium having such software or computer program recorded on it is a computer program product. The use of the computer program product in the model identification server 112 preferably effects an apparatus for adaptively identifying an optimal model to select a route to a location.

In some instances, the application programs 1833 may be supplied to the user encoded on one or more CD-ROMs 1825 and read via the corresponding drive 1812, or alternatively may be read by the user from the networks 1820 or 1822. Still further, the software can also be loaded into the model identification server 112 from other computer readable media. Computer readable storage media refers to any non-transitory tangible storage medium that provides recorded instructions and/or data to the model identification server 112 for execution and/or processing by the processor 1805. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1801. Examples of transitory or non-tangible computer readable transmission media that may also participate in the provision of software, application programs, instructions and/or data to the computer module 1801 include radio or infra-red transmission channels as well as a network connection to another computer or networked device, and the Internet or Intranets including e-mail transmissions and information recorded on Websites and the like.

The second part of the application programs 1833 and the corresponding code modules mentioned above may be executed to implement one or more API of the model identification server 112 with associated graphical user interfaces (GUIs) to be rendered or otherwise represented upon the display 1814 or the display of the provider device 104 and the requestor device 102. Through manipulation of typically the keyboard 1802 and the mouse 1803, an operator of the server 112 and the application may manipulate the interface in a functionally adaptable manner to provide controlling commands and/or input to the applications associated with the GUI(s). Similarly, on the provider device 104 and the requestor device 102, a user of those devices 102, 104 manipulate the input devices (e.g., touch screen, keyboard, mouse, etc.) of those devices 102, 104 in a functionally adaptable manner to provide controlling commands and/or input to the applications associated with the GUI(s). Other forms of functionally adaptable user interfaces may also be implemented, such as an audio interface utilizing speech prompts output via the loudspeakers 1817 and user voice commands input via the microphone 680. These other forms of functionally adaptable user interfaces may also be implemented on the provider device 104 and the requestor device 102.

It is to be understood that the structural context of the coordination server 108 is presented merely by way of example. Therefore, in some arrangements, one or more features of the coordination server 108 may be omitted. Also, in some arrangements, one or more features of the model identification server 112 may be combined. Additionally, in some arrangements, one or more features of the model identification server 112 may be split into one or more component parts.

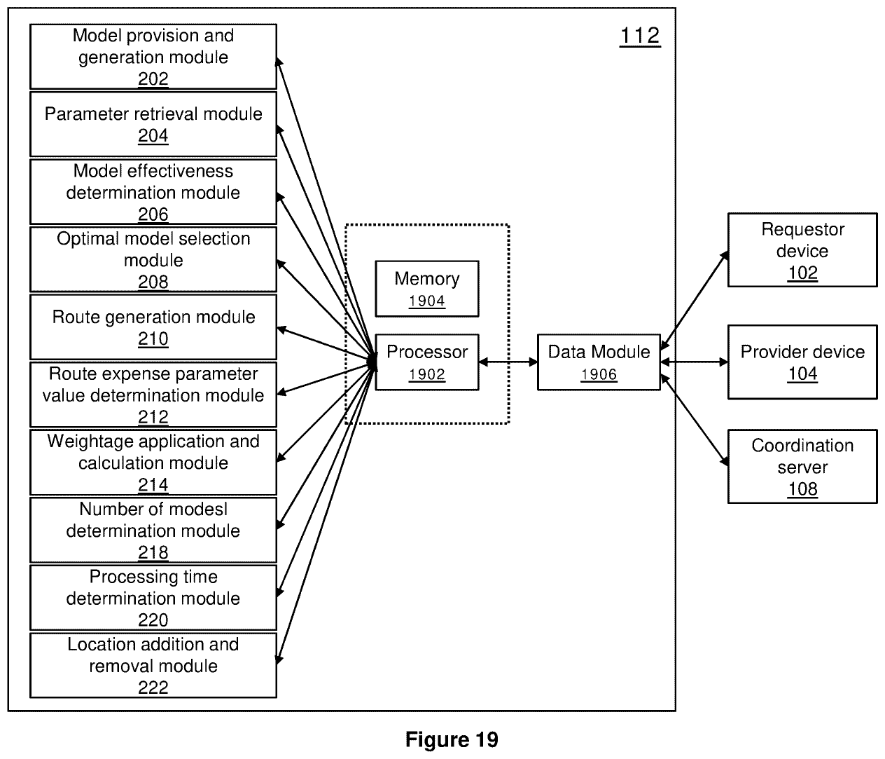

FIG. 19 shows an alternative computer device to implement the model identification server 112 of FIG. 1. In the alternative implementation, the model identification server 112 may be generally described as a physical device comprising at least one processor 1302 and at least one memory 1904 including computer program codes. The at least one memory 1904 and the computer program codes are configured to, with the at least one processor 1902, cause the model identification server 112 of FIG. 1 to perform the operations described in the processes of FIGS. 3, 6-9 and 11. The model identification server 112 may include various modules 202-222 of the system 200 described in FIG. 2. The memory 1904 stores computer program code that the processor 1902 compiles to have each of the modules 202-222 performs their respective functions as described in FIG. 2 and its accompanying description.

The model identification server 112 may also include a data module 1906 configured to perform the functions of receiving data including location data, vehicle data, route data, model data, routing constraint data (or data and parameters input to ProblemContext entity 404) and/or transaction data from the requestor device 102, provider device 104, coordination server 108, a cloud and other sources of information to facilitate the processes of FIGS. 3, 6-9 and 11. For example, the data module 1906 may be configured to receive a request including data including location data, vehicle data, route data, model data, routing constraint data (or data and parameters input to ProblemContext entity 404) and/or transaction data from one user device (such as the requestor device 112 or the provider device 114) the coordination server 108 for use in the adaptive model identification and route selection/generation processes.

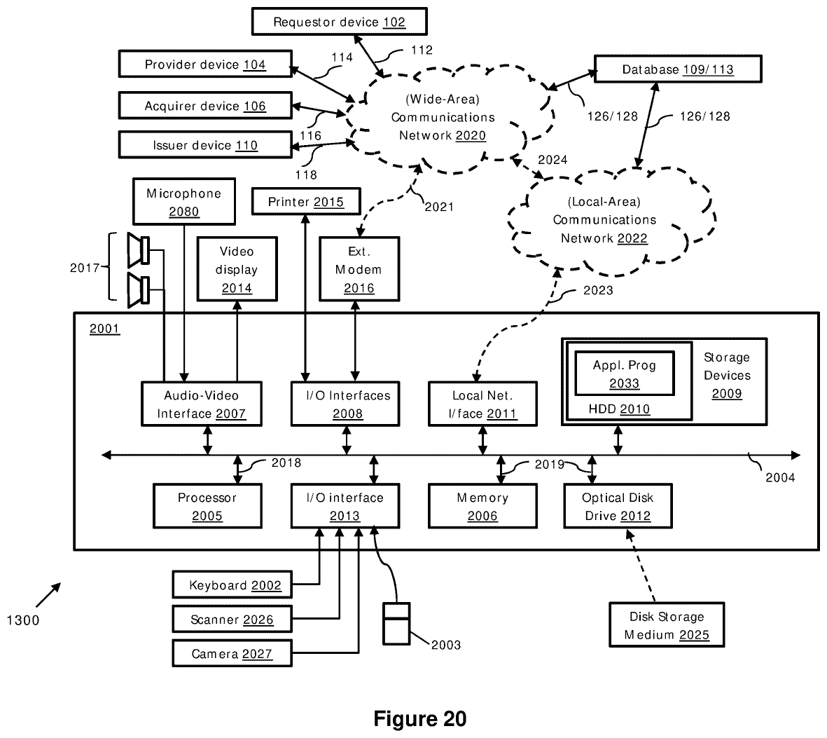

FIG. 20 shows a schematic diagram of a general purpose computer system upon which a combined coordination and model identification server 108, 112 of FIG. 1 can be practiced. The computer system 2000 includes: a computer module 2001, input devices such as a keyboard 2002, a mouse pointer device 2003, a scanner 2026, a camera 2027, and a microphone 2080; and output devices including a printer 2015, a display device 2014 and loudspeakers 2017. An external Modulator-Demodulator (Modem) transceiver device 2016 may be used by the computer module 2001 for communicating to and from a communications network 2020 via a connection 2021. The communications network 2020 may be a wide-area network (WAN), such as the Internet, a cellular telecommunications network, or a private WAN. Where the connection 2021 is a telephone line, the modem 2016 may be a traditional “dial-up” modem. Alternatively, where the connection 2021 is a high capacity (e.g., cable) connection, the modem 2013 may be a broadband modem. A wireless modem may also be used for wireless connection to the communications network 1820.

The input and output devices may be used by an operator who is interacting with the combined coordination and model identification server 108, 112. For example, the printer 2015 may be used to print reports relating to the status of the combined coordination and model identification server 108, 112.

The combined coordination and model identification server 108, 112 uses the communications network 2020 to communicate with the provider device 104, the requestor device 102, and the databases 109, 113 to receive commands and data. In one example, the databases 109, 113 may be combined, as shown in FIG. 20. The combined coordination and model identification server 108, 112 also uses the communications network 2020 to communicate with the provider device 104, the requestor device 102 and the databases 109, 113 to send notification messages or transaction/location/route/vehicle/model data.

The computer module 2001 typically includes at least one processor unit 2005, and at least one memory unit 2006. For example, the memory unit 2006 may have semiconductor random access memory (RAM) and semiconductor read only memory (ROM). The computer module 2001 also includes a number of input/output (I/O) interfaces including: an audio-video interface 2007 that couples to the video display 2014, loudspeakers 2017 and microphone 2080; an I/O interface 2013 that couples to the keyboard 2002, mouse 2003, scanner 2026, camera 2027 and optionally a joystick or other human interface device (not illustrated); and an interface 2008 for the external modem 2016 and printer 2015. In some implementations, the modem 2016 may be incorporated within the computer module 2001, for example within the interface 2008. The computer module 2001 also has a local network interface 2011, which permits coupling of the computer system 2000 via a connection 223 to a local-area communications network 2022. known as a Local Area Network (LAN). As illustrated in FIG. 20, the local communications network 2022 may also couple to the wide network 2020 via a connection 2024, which would typically include a so-called “firewall” device or device of similar functionality. The local network interface 2011 may comprise an Ethernet circuit card, a Bluetooth® wireless arrangement or an IEEE 802.11 wireless arrangement; however, numerous other types of interfaces may be practiced for the interface 2011.

The I/O interfaces 2008 and 2013 may afford either or both of serial and parallel connectivity, the former typically being implemented according to the Universal Serial Bus (USB) standards and having corresponding USB connectors (not illustrated). Storage devices 2009 are provided and typically include a hard disk drive (HDD) 2010. Other storage devices such as a floppy disk drive and a magnetic tape drive (not illustrated) may also be used. An optical disk drive 2012 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the combined coordination and model identification server 108, 112.

The components 2005 to 2013 of the computer module 2001 typically communicate via an interconnected bus 2004 and in a manner that results in a conventional mode of operation of a computer system known to those in the relevant art. For example, the processor 2005 is coupled to the system bus 2004 using a connection 2018. Likewise, the memory 2006 and optical disk drive 2012 are coupled to the system bus 2004 by connections 2019. Examples of computers on which the described arrangements can be practised include IBM-PC's and compatibles, Sun Sparcstations, Apple Mac™ or like computer systems.

The methods of operating the combined coordination and model identification server 108, 112, as shown in the processes of FIGS. 2 and 5-7, may be implemented as one or more software application programs 2033 executable within the combined coordination and model identification server 108, 112. In particular, the steps of the processes shown in FIGS. 2 and 5-7 are effected by instructions (see corresponding component 1531 in FIG. 15) in the software (i.e., computer program codes) 2033 that are carried out within the combined coordination and model identification server 108, 112. The software instructions 1531 may be formed as one or more code modules, each for performing one or more particular tasks. The software may also be divided into two separate parts, in which a first part and the corresponding code modules performs the operation of the combined coordination and model identification server 108, 112 and a second part and the corresponding code modules manages the API and corresponding user interfaces in the provider device 104, the requestor device 102, and on the display 2014. In other words, the second part of the software manages the interaction between (a) the first part and (b) any one of the provider device 104, the requestor device 102, and the operator of the server 112.

The software may be stored in a computer readable medium, including the storage devices described below, for example. The software is loaded into the combined coordination and model identification server 108, 112 from the computer readable medium, and then executed by the computer system 2000. A computer readable medium having such software or computer program recorded on the computer readable medium is a computer program product. The use of the computer program product in the combined coordination and model identification server 108, 112 preferably effects an advantageous apparatus for adaptively identifying an optimal model to select a route to a location as well as for receiving/transmitting data including location data, vehicle data, route data, model data, routing constraint data (or data and parameters input to ProblemContext entity 404) and/or transaction data used for the adaptive optimal model identification and route selection/generation processes performed by the model identification server 112.

The software (i.e., computer program codes) 2033 is typically stored in the HDD 2010 or the memory 2006. The software 2033 is loaded into the computer system 2000 from a computer readable medium (e.g., the memory 2006), and executed by the processor 2005. Thus, for example, the software 2033 may be stored on an optically readable disk storage medium (e.g., CD-ROM) 2025 that is read by the optical disk drive 2012. A computer readable medium having such software or computer program recorded on it is a computer program product. The use of the computer program product in the combined coordination and model identification server 108, 112 preferably effects an apparatus for adaptively identifying an optimal model to select a route to a location as well as for receiving/transmitting data including location data, vehicle data, route data, model data, routing constraint data (or data and parameters input to ProblemContext entity 404) and/or transaction data used for the adaptive optimal model identification and route selection/generation processes.

In some instances, the application programs 2033 may be supplied to the user encoded on one or more CD-ROMs 2025 and read via the corresponding drive 2012, or alternatively may be read by the user from the networks 2020 or 2022. Still further, the software can also be loaded into the combined coordination and model identification server 108, 112 from other computer readable media. Computer readable storage media refers to any non- transitory tangible storage medium that provides recorded instructions and/or data to the combined coordination and model identification server 108, 112 for execution and/or processing by the processor 2005. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 2001. Examples of transitory or non-tangible computer readable transmission media that may also participate in the provision of software, application programs, instructions and/or data to the computer module 2001 include radio or infra-red transmission channels as well as a network connection to another computer or networked device, and the Internet or Intranets including e-mail transmissions and information recorded on Websites and the like.

The second part of the application programs 2033 and the corresponding code modules mentioned above may be executed to implement one or more API of the combined coordination and model identification server 108, 112 with associated graphical user interfaces (GUIs) to be rendered or otherwise represented upon the display 2014 or the display of the provider device 104 and the requestor device 102. Through manipulation of typically the keyboard 2002 and the mouse 2003, an operator of the server 112 and the application may manipulate the interface in a functionally adaptable manner to provide controlling commands and/or input to the applications associated with the GUI(s). Similarly, on the provider device 104 and the requestor device 102, a user of those devices 102, 104 manipulate the input devices (e.g., touch screen, keyboard, mouse, etc.) of those devices 102, 104 in a functionally adaptable manner to provide controlling commands and/or input to the applications associated with the GUI(s). Other forms of functionally adaptable user interfaces may also be implemented, such as an audio interface utilizing speech prompts output via the loudspeakers 2017 and user voice commands input via the microphone 680. These other forms of functionally adaptable user interfaces may also be implemented on the provider device 104 and the requestor device 102.

It is to be understood that the structural context of the coordination server 108 is presented merely by way of example. Therefore, in some arrangements, one or more features of the coordination server 108 may be omitted. Also, in some arrangements, one or more features of the combined coordination and model identification server 108, 112 may be combined. Additionally, in some arrangements, one or more features of the combined coordination and model identification server 108, 112 may be split into one or more component parts.

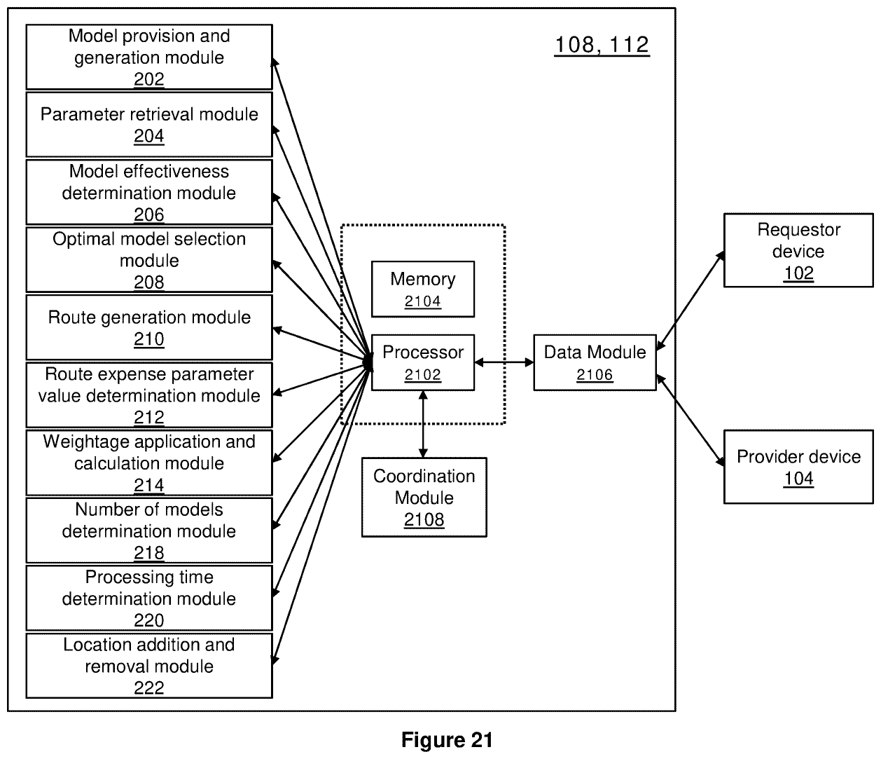

FIG. 21 shows an alternative computer device to implement a combined coordination and model identification server 108, 112 of FIG. 1. In the alternative implementation, the combined coordination and model identification server 108, 112 may be generally described as a physical device comprising at least one processor 2102 and at least one memory 2104 including computer program codes. The at least one memory 2104 and the computer program codes are configured to, with the at least one processor 2102, cause the combined coordination and model identification server 108, 112 to perform the operations described in the processes of FIGS. 3, 6-9 and 11. The combined coordination and model identification server 108, 112 may include various modules 202-222 of the system 200 described in FIG. 2. The memory 2104 stores computer program code that the processor 2102 compiles to have each of the modules 202-222 performs their respective functions as described in FIG. 2 and its accompanying description.

The combined coordination and model identification server 108, 112 may also include a coordination module 1508 configured to perform the function of communicating with the requestor device 102 and the provider device 104; and the acquirer server 106 and the issuer server 110 to respectively receive and transmit data including location data, vehicle data, route data, model data, routing constraint data (or data and parameters input to ProblemContext entity 404) and/or transaction data that are used for the adaptive optimal model identification and route selection/generation processes.

The combined coordination and model identification server 108, 112 may also include a data module 2106 configured to perform the functions of receiving t data including location data, vehicle data, route data, model data, routing constraint data (or data and parameters input to ProblemContext entity 404) and/or transaction data from the requestor device 102, provider device 104, coordination server 108, a cloud and other sources of information to facilitate the processes of FIGS. 3, 6-9 and 11. For example, the data module 1506 may be configured to receive a request with data including location data, vehicle data, route data, model data, routing constraint data (or data and parameters input to ProblemContext entity 404) and/or transaction data from one user device (such as the requestor device 112 or the provider device 114) to perform the adaptive model identification and route selection/generation processes.

The foregoing describes only some embodiments of the present disclosure, and modifications and/or changes can be made thereto without departing from the scope and spirit of the invention, the embodiments being illustrative and not restrictive.

1. A method for adaptively identifying an optimal model to select a route to a location, comprising:
providing one or more first models based on a routing characteristic associated with the location;
retrieving one or more first parameters associated with the routing characteristic to determine an effectiveness of each of the one or more first models in minimizing a route expense parameter; and
selecting the optimal model from the one or more first models based on the effectiveness.

2. The method of claim 1, wherein the step of retrieving one or more first parameters associated with a routing characteristic to determine an effectiveness of each of the one or more first models in minimizing a route expense parameter comprises:
for the each of the one or more first models, generating at least one of a first route to the location, a first vehicle type, a first distance, a first time and a first load of the location, and wherein the step of selecting the optimal model from the one or more first models comprises:
identifying that at least one of the first route to the location, the first vehicle type, the first distance, the first time and the first load of the location of one of the one or more first models as those of the optimal model.

3. The method of claim 1, wherein the one or more first parameters comprises at least one of a location coordinate, a distance, a time, a load and a number of items to be unloaded/picked up at the location; a type, a load capacity, a speed and a capability of a vehicle; a number of available vehicles; and an accumulated time constraint, an accumulated distance constraint, an accumulated load constraint, a route sequence constraint, an arrival time window constraint and a vehicle type constraint associated with the location.

4. The method of claim 1, wherein the step of retrieving one or more first parameters associated with a routing characteristic to determine an effectiveness of each of the one or more first models in minimizing a route expense parameter comprises:
for the each of the one or more first models, determining a value of the routing expense parameter based on the one or more first parameters of the each of the one or more first models, a high value in the route expense parameter indicating a low effectiveness in minimizing the route expense parameter, wherein the step of selecting the optimal model from the one or more first models is based on the value of the route expense parameter.

5. The method of claim 1, further comprising:
generating a second model from the optimal model;
determining if an effectiveness of the second model in minimizing the route expense parameter is greater than that of the optimal model;
setting the second model as the optimal model in response to a result of the determination.

6. The method of claim 5, wherein the step of generating the second model from the optimal model comprises:
generating at least one of a second route to the location, a second vehicle type, a second distance, a second time and a second load of the location, and wherein the step of setting the second model as the optimal model in response to a result of the determination comprises:
identifying the at least one of the second route to the location, the second vehicle type, the second distance, the second time and the second load of the location of the second model as those of the optimal model.

7. The method of claim 6, the step of generating the second route to the location comprises one of:
(a) adding a new location to the route; or (b) wherein the location is one of a plurality of locations and the route to the location selected by the optimal model is a route connecting the plurality of locations in a sequence, removing the location from the route, or switching the sequence of the location and another location of the plurality of locations.

8. The method of claim 5, further comprising:
determining if the effectiveness of the second model is greater than an effectiveness of a previously generated second model.

9. The method of claim 5, wherein the second model is one of a plurality of second models and the generation of the second model is based on a weightage, the second model having a highest weightage as compared to that of the remaining of the plurality of second models.

10. The method of claim 5, further comprising:
determining if a total number of second models generated or a total processing time exceed a pre-configured threshold condition, the total processing time representing a total time spent in adaptively identifying the optimal model to select the route to the location, wherein the generation of the second model from the optimal route is carried out in response to determining the total number of second models or the total processing time does not exceed the pre-configured threshold condition.

11. A system for identifying an optimal route connecting a plurality of destinations, the system comprising:
at least one processor; and
at least one memory including computer program code;
the at least one memory and the computer program code configured to, with at least one processor, cause the server at least to, comprising:
provide one or more first models based on a routing characteristic associated with the location;
retrieve one or more first parameters associated with the routing characteristic to determine an effectiveness of each of the one or more first models in minimizing a route expense parameter; and
select the optimal model from the one or more first models based on the effectiveness.

12. The system of claim 11, wherein the at least one memory and the computer program code configured to, with the at least one processor, cause the server at least to, further: for the each of the one or more first models, generate at least one of a first route to the location, a first vehicle type, a first distance, a first time and a first load of the location; and
identify that at least one of the first route to the location, the first vehicle type, the first distance, the first time and the first load of the location of one of the one or more first models as those of the optimal model.

13. The system of claim 11, wherein the one or more first parameters comprises at least one of a location coordinate, a distance, a time, a load and a number of items to be unloaded/picked up at the location; a type, a load capacity, a speed and a capability of a vehicle; a number of available vehicles; and an accumulated time constraint, an accumulated distance constraint, an accumulated load constraint, a route sequence constraint, an arrival time window constraint and a vehicle type constraint associated with the location.

14. The system of claim 11, wherein the at least one memory and the computer program code configured to, with the at least one processor, cause the server at least to, further:
for the each of the one or more first models, determine a value of the route expense parameter based on the one or more first parameters of the each of the one or more first models;
a high value in the route expense parameter indicating a low effectiveness in minimizing the route expense parameter, wherein the step of selecting the optimal model from the one or more first models is based on the value of the route expense parameter.

15. The system of claim 11, wherein the at least one memory and the computer program code configured to, with the at least one processor, cause the server at least to further: generate a second model from the optimal model;
determine if the effectiveness of the second model in minimizing the route expense parameter is greater than that of the optimal model;
set the second model as the optimal model in response to a result of the determination.

16. The system of claim 15, wherein, to generate the second model from the optimal model, the at least one memory and the computer program code configured to, with the at least one processor, cause the server at least to:
generate at least one of a second route to the location, a second vehicle type, a second distance, a second time and a second load of the location:
identify the at least one of the second route to the location, the second vehicle type, the second distance, the second time and the second load of the location of the second model as those of the optimal model.

17. The system of claim 16, to generate the second route to the location, the at least one memory and the computer program code configured to, with the at least one processor, cause the server at least to perform one of:
(a) an addition of a new location to the route; or
(b) wherein the location is one of a plurality of locations and the route to the location selected by the optimal model is a route connecting the plurality of locations in a sequence, a removal of the location from the route, or a switching of the sequence of the location and another location of the plurality of locations.

18. The system of claim 15, wherein the at least one memory and the computer program code configured to, with the at least one processor, cause the server at least to:
determine if the effectiveness of the second model is greater than an effectiveness of a previously generated second model, wherein the setting of the second model as the
optimal model is carried out in further response to determining the effectiveness of the second model being greater than the effectiveness of the previously generated second model.

19. The system of claim 15 wherein the second model is one of a plurality of second models and the generation of the second model is based on a weightage, the second model having a highest weightage as compared to that of the remaining of the plurality of second models.

20. The system of claim 15, wherein the at least one memory and the computer program code configured to, with the at least one processor, cause the server at least to further:
determine if a total number of second models generated or a total processing time exceed a pre-configured threshold condition, the total processing time representing a total time spent in adaptively identifying the optimal model to select the route to the location, wherein the generation of the second model from the optimal route is carried out in response to determining the total number of second models or the total processing time does not exceed the pre- configured threshold condition.
